(19) United States
(12) Patent Application Publication
(10) Pub. No.: US 2025/0284217 A1
(43) Pub. Date: Sep. 11, 2025

(54) RESIN PARTICLE, METHOD OF MANUFACTURING RESIN PARTICLE, TONER, TONER STORAGE CONTAINER, AND IMAGE FORMING APPARATUS

(71) Applicants: Tsuneyasu NAGATOMO, Kanagawa (JP); Yuka MIZOGUCHI, Kanagawa (JP); Akio TAKEI, Kanagawa (JP); Masahiro YUKIKAWA, Kanagawa (JP)

(72) Inventors: Tsuneyasu NAGATOMO, Kanagawa (JP); Yuka MIZOGUCHI, Kanagawa (JP); Akio TAKEI, Kanagawa (JP); Masahiro YUKIKAWA, Kanagawa (JP)

(21) Appl. No.: 19/067,993

(22) Filed: Mar. 3, 2025

(30) Foreign Application Priority Data
Mar. 6, 2024 (JP) 2024-033721

(51) Int. Cl. G03G 9/08; G03G 9/087; G03G 9/093; G03G 15/08

(52) U.S. Cl. CPC G03G 9/0825; G03G 9/0804; G03G 9/0819; G03G 9/08755; G03G 9/09328; G03G 15/08

(57) ABSTRACT

A resin particle is provided that includes: a base particle including at least one of polyethylene terephthalate or polybutylene terephthalate and having a BET specific surface area of 0.8 to 1.4 m²/g; and an external additive including fine particles A having an average particle size of 100 nm or more and fine particles B having an average particle size of 10 to 50 nm, a mass ratio A/B of the fine particles A to the fine particles B being 0.5 to 1.4.

### CROSS-REFERENCE TO RELATED APPLICATIONS

This patent application is based on and claims priority pursuant to 35 U.S.C. § 119(a) to Japanese Patent Application No. 2024-033721, filed on Mar. 6, 2024, in the Japan Patent Office, the entire disclosure of which is hereby incorporated by reference herein.

### BACKGROUND

### Technical Field

The present disclosure relates to a resin particle, a method of manufacturing a resin particle, a toner, a toner storage container, and an image forming apparatus.

### Related Art

Resin particles are widely used in various locations, such as offices, as toners used in image forming apparatuses, such as multifunction peripherals (MFP) and printers. In order to reduce the impact of toners on the environment, for example, reduction of power consumption by improving the low-temperature fixing properties of the toner itself, reduction of energy usage during manufacturing, use of biomass (plant) derived resins as binder resins, and use of recycled raw materials in binder resins, are being investigated. In particular, because resource conservation, energy saving, recycling of resource, and the like, are attracting attention, there is an increasing demand for the use of recycled raw materials in binder resins.

### SUMMARY

Embodiments of the present invention provides a resin particle that includes: a base particle including at least one of polyethylene terephthalate or polybutylene terephthalate and having a BET specific surface area of 0.8 to 1.4 m²/g; and an external additive including fine particles A having an average particle size of 100 nm or more and fine particles B having an average particle size of 10 to 50 nm, a mass ratio A/B of the fine particles A to the fine particles B being 0.5 to 1.4.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus according to an embodiment of the present invention; and

FIG. 2 is a schematic view of a process cartridge according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present invention provide a resin particle that reduces environmental impact, has excellent charging properties even when polyethylene terephthalate or polybutylene terephthalate is used, and can form an image having an excellent image quality even under a high humidity environment.

Hereinafter, an embodiment of the present invention will be described in detail. Note that the embodiment is not limited by the description below, and can be modified as appropriate in a range not departing from the spirit of the present invention. Furthermore, the phrase “X to Y” or “from X to Y” used herein, which indicates a numerical value range, refers to a range that includes X and Y as the lower limit value and upper limit value, unless otherwise stated.

### <Resin Particle>

The resin particle according to an embodiment will be described. The resin particle includes a base particle including polyethylene terephthalate (PET) or polybutylene terephthalate (PBT), and an external additive. The resin particle preferably further includes, in addition to PET or PBT, an amorphous resin, a crystalline resin, and a release agent, and may include other components, if preferable.

### [PET or PBT]

The PET or PBT is included in the resin particle mainly for the purpose of reducing environmental impact.

The PET or PBT is not particularly limited, and can be selected as appropriate according to the intended purpose. For example, recycled materials, off-spec textile scraps, or pellets can be used. However, from the viewpoint of reducing environmental impact, it is preferable to use a recycled material (hereinafter, sometimes referred to as “recycled resin”) that has been processed into flakes.

The molecular weight distribution, composition, and manufacturing method of the PET or PBT, and the form when used, are not particularly limited, and can be selected as appropriate according to the intended purpose.

The weight average molecular weight (Mw) of the PET or PBT is not particularly limited, and can be selected as appropriate according to the intended purpose, but is preferably 30,000 to 100,000.

The analytical method and calculation method of the content of PET or PBT in the resin particle are not particularly limited, and a general calculation method of the blended amount of PET can be used. Examples of the analytical method and calculation method of the content of PET or PBT include calculating a mass ratio of the constituent components of the resin particle by separation from the resin particle by gel permeation chromatography (GPC) and the like, and then using the analytical method described below with respect to each separated component.

Furthermore, quantitative analysis can also be performed by estimating the main constituent components from a soft decomposition of the ester bonds in the resin particle by methylation using gas chromatography/mass spectrometry (GC/MS) at 300° C. using a reaction reagent (10% tetramethylammonium hydroxide (TMAH)/methanol solution), and drawing a calibration curve of the total ion current chromatogram (TICC) intensity.

The separation of each component by GPC can be performed, for example, by the following method.

In a GPC measurement using tetrahydrofuran (THF) as the mobile phase, the eluate is fractionated by using a fraction collector or the like, and fractions corresponding to desired molecular weight portions among the total area of the elution curve are combined.

The combined eluate is concentrated and dried by using an evaporator or the like, and the solid content then is dissolved in a deuterated solvent such as deuterated chloroform or deuterated THF, and an ¹H-NMR measurement is performed. The ratio of the constituent monomers of the resin in the eluted components is calculated from the integral ratios of the elements.

Furthermore, as another method, the eluate is concentrated, and then subjected to hydrolysis using sodium hydroxide or the like. The decomposition products are qualitatively and quantitatively analyzed by high-performance liquid chromatography (HPLC) or the like to calculate the ratio of the constituent monomers.

The content of PET or PBT is not particularly limited, and can be selected as appropriate according to the intended purpose. However, the content is preferably 30% by mass or more, and more preferably 30% to 70% by mass or more with respect to the total mass of the resin particle. When the content of PET or PBT with respect to the total mass of the resin particle is 70% by mass or less, low-temperature fixing properties can be exhibited. When the content of PET or PBT is 30% by mass or more, an effect of reducing the environmental impact can be exhibited, and the resin particle can be provided with an excellent particle size distribution. When the content of PET or PBT is in the more preferable range mentioned above, it is advantageous in that both a reduction in the environmental impact of the resin particle and an improvement in the particle size distribution can be achieved.

An example means of separating the components included in the resin particle when analyzing the resin particle will be described in detail. First, 1 g of the resin particle is placed in 100 mL of THF, and the mixture is stirred for 30 minutes at 25° C. to obtain a solution in which the soluble components are dissolved. The solution is filtered through a membrane filter having 0.2 μm openings to obtain the components of the resin particle that are soluble in THF. Then, the soluble components are dissolved in THF to prepare a GPC measurement sample, and the sample is injected into the GPC used for molecular weight measurements of each of the resins mentioned above. Meanwhile, a fraction collector is arranged at an eluate discharge port of the GPC to collect the eluate at predetermined counts, and the eluate is collected at each 5% of the area ratio from the start of elution (rise of the curve) of the elution curve. Next, for each elution fraction, 30 mg of the sample is dissolved in 1 mL of deuterated chloroform, and 0.05 vol % of tetramethylsilane (TMS) is added as a reference substance. The solution is filled into a glass tube for NMR measurement having a diameter of 5 mm, and a nuclear magnetic resonance device (JNM-AL400 manufactured by JEOL Ltd.) is used at a temperature of 23° C. to 25° C., and a spectrum is obtained by performing 128 integrations. The monomer composition and constituent ratio of the PET resin and the like included in the resin particle can be determined from the peak integral ratio of the obtained spectrum.

Therefore, the resin particle can both reduce environmental impact and have an excellent particle size distribution.

As described above, the resin particle preferably includes, in addition to PET or PBT, an amorphous resin, a crystalline resin, and a release agent.

The total content of PET or PBT with respect to the total mass of the resin particle is preferably 30% by mass or more, more preferably 40% by mass or more, and even more preferably 50% by mass or more.

### [Amorphous Resin]

The resin particle preferably includes an amorphous resin.

The amorphous resin is preferably a terpene resin or an amorphous (non-crystalline) polyester resin (hereinafter, also referred to as “amorphous polyester resin B”), and among such resins, linear polyester resins are preferable, and unmodified polyester resins are also preferable. In the present embodiment, the amorphous resin refers to a resin that excludes PET or PBT.

The unmodified polyester resin is a polyester resin obtained using a polyhydric alcohol, and a polycarboxylic acid or a derivative thereof, such as a polycarboxylic acid, a polycarboxylic anhydride, or a polycarboxylic ester, and is a polyester resin that is not modified with an isocyanate compound or the like.

The amorphous polyester resin preferably does not contain a urethane bond or a urea bond.

The amorphous polyester resin includes a dicarboxylic acid component as a constituent component, and the dicarboxylic acid component preferably includes 50 mol % or more of terephthalic acid. This is advantageous in terms of the heat-resistant storage stability.

Examples of the polyhydric alcohol include, but are not limited to, diols.

Examples of the diol include, but are not limited to, alkylene (2 to 3 carbon atoms) oxide adducts of bisphenol A (1 to 10 average moles added), such as polyoxypropylene (2.2)-2,2-bis(4-hydroxyphenyl) propane and polyoxyethylene (2.2)-2,2-bis(4-hydroxyphenyl) propane; ethylene glycol, neopentyl glycol, propylene glycol, hydrogenated bisphenol A, and alkylene (2 to 3 carbon atoms) oxide adducts of hydrogenated bisphenol A (1 to 10 average moles added).

These diols may be used alone or in combination of two or more types.

Among these diols, it is preferable to include plant-derived ethylene glycol and propylene glycol.

Examples of the polycarboxylic acid include, but are not limited to, dicarboxylic acids.

Examples of the dicarboxylic acid include, but are not limited to, adipic acid, phthalic acid, isophthalic acid, terephthalic acid, fumaric acid, maleic acid, succinic acids substituted with an alkyl group having 1 to 20 carbon atoms or an alkenyl group having 2 to 20 carbon atoms, such as dodecenylsuccinic acid and octylsuccinic acid; and modified purified rosin. The modified purified rosin is preferably modified with acrylic acid, fumaric acid, or maleic acid.

Among these dicarboxylic acids, it is preferable to include succinic acid, which is a plant-derived saturated aliphatic acid, and modified purified rosin. The use of plant-derived dicarboxylic acids can enhance carbon neutrality. The saturated aliphatic group has the effect of enhancing the recrystallization properties of the crystalline polyester resin, and can increase the aspect ratio of the crystalline polyester resin, which enables the low-temperature fixing properties to be improved.

These dicarboxylic acids may be used alone or in combination of two or more types.

Furthermore, for the purpose of adjusting the acid value or hydroxyl value, the amorphous polyester resin may include at least one of a trivalent or higher carboxylic acid and a trihydric or higher alcohol at the end of the resin chain.

Examples of the trivalent or higher carboxylic acid include trimellitic acid, pyromellitic acid, and acid anhydrides thereof.

Examples of the trihydric or higher alcohol include glycerin, pentaerythritol, and trimethylolpropane.

The molecular weight of the amorphous polyester resin is not particularly limited, and can be selected as appropriate according to the intended purpose. In the gel permeation chromatography (GPC) measurement, the weight average molecular weight is preferably 3,000 to 10,000. The number average molecular weight (Mn) is more preferably 1,000 to 4,000. The ratio Mw/Mn of the weight average molecular weight (Mw) to the number average molecular weight (Mn) is preferably 1.0 to 4.0.

In the case where the molecular weight is greater than or equal to the lower limit above, the resin particle is prevented from decreasing the heat-resistant storage stability and the durability with respect to the stress caused by stirring in a development machine and the like. In the case where the molecular weight is less than or equal to the upper limit above, the resin particle is prevented from increasing the viscoelasticity when melted and decreasing the low-temperature fixing properties.

The weight average molecular weight (Mw) is more preferably 4,000 to 7,000. The number average molecular weight (Mn) is more preferably 1,500 to 3,000. The ratio Mw/Mn of the weight average molecular weight (Mw) to the number average molecular weight (Mn) is more preferably 1.0 to 3.5.

The acid value of the amorphous polyester resin is not particularly limited, and can be selected as appropriate according to the intended purpose. The acid value is preferably 1 mgKOH/g to 50 mgKOH/g, and more preferably 5 mgKOH/g to 30 mgKOH/g. As a result of the acid value being 1 mgKOH/g or more, the resin particle tend to be negatively charged. Further, when fixed to paper, the affinity between the paper and the resin particle is improved, which improves the low-temperature fixing properties. As a result of the acid value being 50 mgKOH/g or less, a decrease in the charging stability, and in particular, the charging stability with respect to environmental fluctuations, can be prevented.

The hydroxyl value of the amorphous polyester resin is not particularly limited, and can be selected as appropriate according to the intended purpose, but is preferably 5 mg KOH/g or more.

The glass transition temperature (Tg) of the amorphous polyester resin is preferably 40° C. to 80° C., and more preferably 50° C. to 70° C. As a result of the glass transition temperature (Tg) being 40° C. or higher, the resin particle has sufficient heat-resistant storage stability and durability with respect to the stress caused by stirring in a development machine and the like, and also has good filming resistance. As a result of the glass transition temperature (Tg) being 80° C. or lower, the resin particle is sufficiently deformed by the application of heat and pressure during fixing, resulting in good low-temperature fixing properties.

The molecular structure of the amorphous polyester resin can be confirmed by an NMR measurement of a liquid or solid sample, and further, by X-ray diffraction, GC/MS, LC/MS, IR measurements, and the like. Examples of simple methods include, but are not limited to, detecting resins that do not display absorption at 965±10 cm⁻¹ and 990±10 cm⁻¹ due to δ_{CH} (out-of-plane bending vibration) of an olefin in the infrared absorption spectrum as amorphous polyester resins.

The content of the amorphous resin is not particularly limited, and can be selected as appropriate according to the intended purpose. The content of the amorphous resin is preferably 50 parts by mass to 90 parts by mass, and more preferably 60 parts by mass to 80 parts by mass with respect to 100 parts by mass of the resin particle. When the content is 50 parts by mass or more, a deterioration in the dispersibility of pigments and release agents in the resin particle can be prevented, and the occurrence of image fogging and distortion can be prevented. When the content is 90 parts by mass or less, for example, the content of a crystalline polyester resin C and an amorphous polyester resin B described below can be prevented from becoming low, and to prevent a decrease in the low-temperature fixing properties. When the content is in the more preferable range mentioned above, it is advantageous in that both a high image quality and excellent low-temperature fixing properties can be achieved.

### [Non-Crystalline Resin (Prepolymer)]

The resin particle may include a non-crystalline resin (prepolymer) as an amorphous resin for improving the low-temperature fixing properties, and the prepolymer is preferably modified with an isocyanate compound or the like.

Examples of reactive precursors include, but are not limited to, polyesters having a group reactive with an active hydrogen group.

Examples of groups reactive with an active hydrogen group include, but are not limited to, an isocyanate group, an epoxy group, a carboxylic acid, and an acid chloride group. Among these reactive groups, an isocyanate group is preferable because it is possible to introduce urethane bonds or urea bonds into the amorphous polyester resin.

The reactive precursor may have a branched structure imparted by at least one of a trihydric or higher alcohol and a trivalent or higher carboxylic acid.

Examples of polyester resins containing an isocyanate group include, but are not limited to, a reaction product of a polyester resin having an active hydrogen group with a polyisocyanate (hereinafter, sometimes referred to as amorphous polyester resin A).

The polyester resin having an active hydrogen group can be obtained, for example, by polycondensation of a diol, a dicarboxylic acid, and at least one of a trihydric or higher alcohol and a trivalent or higher carboxylic acid. The trihydric or higher alcohol and the trivalent or higher carboxylic acid impart a branched structure to the polyester resin containing an isocyanate group.

Examples of the diol include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; oxyalkylene group-containing diols such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; alkylene oxide adducts of alicyclic diols, the alkylene oxide being ethylene oxide, propylene oxide, and butylene oxide; bisphenols such as bisphenol A, bisphenol F, and bisphenol S; and alkylene oxide adducts of bisphenols, the alkylene oxide being ethylene oxide, propylene oxide, and butylene oxide. Among these diols, from the viewpoint of controlling the glass transition temperature (Tg) of the amorphous polyester resin A to 20° C. or lower, it is preferable to use an aliphatic diol having 3 or more and 10 or less carbon atoms, such as 1,2-propylene glycol, 1,3-propylene glycol, 1,4-butanediol, 2-methyl-1,3-propanediol, 1,5-pentanediol, or 3-methyl-1,5-pentanediol, and it is more preferable to use 50 mol % or more of the alcohol component in the resin. These diols may be used alone or in combination of two or more types.

As a result of the amorphous polyester resin A having steric hindrance in the resin chain, it becomes easier to reduce the melt viscosity during fixing, and for low-temperature fixing properties to be exhibited. For this reason, the main chain of the aliphatic diol preferably has a structure represented by the following general formula (1).

HO—(CR1R2)n-OH General formula (1)

In general formula (1), R1 and R2 each independently represent a hydrogen atom and an alkyl group having 1 to 3 carbon atoms. n represents an odd number from 3 to 9. In the n repeating units, R1 and R2 may be the same in each unit or may be different.

Here, the main chain of the aliphatic diol refers to the carbon chain that links two hydroxyl groups of the aliphatic diol with the smallest number of carbons atoms. It is preferable that the main chain has an odd number of carbon atoms, because the crystallinity is reduced by the parity. Furthermore, it is more preferable that the side chain has at least one alkyl group having 1 to 3 carbon atoms, since the interaction energy between the main chain molecules is reduced due to the three-dimensionality.

Examples of the dicarboxylic acid include, but are not limited to, aliphatic dicarboxylic acids such as succinic acid, adipic acid, sebacic acid, dodecanedioic acid, maleic acid, and fumaric acid; and aromatic dicarboxylic acids such as phthalic acid, isophthalic acid, terephthalic acid, and naphthalenedicarboxylic acid. Moreover, anhydrides, lower (1 to 3 carbon atoms) alkyl ester compounds, and halide compounds of such dicarboxylic acids may also be used. Among these, from the viewpoint of controlling the glass transition temperature (Tg) of the amorphous polyester resin A to 20° C. or lower, aliphatic dicarboxylic acids having 4 to 12 carbon atoms are preferable, and it is more preferable to use 50% by mass or more of the carboxylic acid component in the resin. These dicarboxylic acids may be used alone, or in combination of two or more types.

Examples of trihydric or higher alcohols include, but are not limited to, trihydric or higher aliphatic alcohols such as glycerin, trimethylolethane, trimethylolpropane, pentaerythritol, and sorbitol; trihydric or higher polyphenols such as trisphenol PA, phenol novolac, and cresol novolac; and alkylene oxide adducts of trihydric or higher polyphenols, such as those obtained by adding alkylene oxides such as ethylene oxide, propylene oxide, and butylene oxide to a trivalent or higher polyphenol.

Examples of trivalent or higher carboxylic acids include, but are not limited to, trivalent or higher aromatic carboxylic acids, and particularly preferable are trivalent or higher aromatic carboxylic acids having 9 to 20 carbon atoms, such as trimellitic acid and pyromellitic acid. Moreover, anhydrides, lower (1 to 3 carbon atoms) alkyl ester compounds, and halide compounds of such trivalent or higher carboxylic acids may also be used.

Examples of the polyisocyanate include, but are not limited to, diisocyanates and trivalent or higher isocyanates.

The polyisocyanate is not particularly limited, and can be selected as appropriate according to the intended purpose. Examples of the polyisocyanate include 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [a phosgenation product of crude diaminophenylmethane [a mixture of a condensation product of formaldehyde and an aromatic amine (aniline) or a mixture thereof, diaminodiphenylmethane, and a small amount (for example, 5 to 20% by mass) of a trifunctional or higher functional polyamine: polyallyl polyisocyanate (PAPI)]], aromatic diisocyanates such as 1,5-naphthylene diisocyanate, 4,4′,4″-triphenylmethane triisocyanate, m- and p-isocyanatophenylsulfonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornane diisocyanate; aromatic aliphatic diisocyanates such as m- and p-xylylene diisocyanate (XDI) and α,α,α′,α′-tetramethylxylylene diisocyanate (TMXDI); trivalent or higher valent polyisocyanates such as lysine triisocyanate and diisocyanate-modified products of trihydric or higher alcohols; and modified products of such isocyanates. Further, two or more types of such isocyanates may be used as a mixture. Examples of the modified isocyanate include, but are not limited to, modified products including a urethane group, a carbodiimide group, an allophanate group, a urea group, a biuret group, a uretdione group, a uretoimine group, an isocyanurate group, and an oxazolidone group.

### [Crystalline Resin]

Preferably, the resin particle contains a crystalline resin to improve the low-temperature fixing properties.

The crystalline resin is not particularly limited as long as the resin has crystallinity, and can be selected as appropriate according to the intended purpose. Examples of the crystalline resin include, but are not limited to, polyester resins, polyurethane resins, polyurea resins, polyamide resins, polyether resins, vinyl resins, and modified crystalline resins. These crystalline resins may be used alone or in combination of two or more types.

The polyester resin used as the crystalline resin is a crystalline polyester resin (hereinafter, sometimes referred to as “crystalline polyester resin C”). The crystalline polyester resin C will be described below.

The crystalline polyester resin C has a high crystallinity, and therefore, exhibits thermal melting characteristics that show a rapid change in viscosity near the fixing start temperature.

As a result of using the crystalline polyester resin C having such characteristics with the amorphous polyester resin B, a resin particle having both good heat-resistant storage stability and low-temperature fixing properties can be obtained. For example, when used together, good heat-resistant storage stability is obtained due to the crystallinity up to just before the melting start temperature. Further, at the melting start temperature, a sudden viscosity drop (sharp melt property) occurs due to melting of the crystalline polyester resin C, and as a result, the crystalline polyester resin C becomes compatible with the amorphous polyester resin B described above, which enables good fixing because both resins rapidly decrease in viscosity.

### (Crystalline Polyester Resin)

The crystalline polyester resin is obtained by using a polyhydric alcohol, and a polyvalent carboxylic acid or a derivative thereof, such as a polyvalent carboxylic acid, a polycarboxylic anhydride, or a polycarboxylic ester.

Note that, in the present embodiment, as described above, the crystalline polyester resin refers to a resin obtained by using a polyhydric alcohol and a polyvalent carboxylic acid or a derivative thereof, such as a polyvalent carboxylic acid, a polycarboxylic anhydride, or a polycarboxylic ester. Further, resins obtained by modifying a polyester resin, such as prepolymers, and resins obtained by subjecting a prepolymer to a crosslinking and/or elongation reaction, are not included in the definition of the crystalline polyester resin.

### ((Polyhydric Alcohol))

The polyhydric alcohol is not particularly limited, and can be selected as appropriate according to the intended purpose. Examples of the polyhydric alcohol include, but are not limited to, diols and trihydric or higher alcohols.

Examples of the diol include, but are not limited to, saturated aliphatic diols. Examples of the saturated aliphatic diol include, but are not limited to, linear saturated aliphatic diols and branched saturated aliphatic diols. Among these saturated aliphatic diols, linear saturated aliphatic diols are preferable, and linear saturated aliphatic diols having 2 to 12 carbon atoms are more preferable. When the saturated aliphatic diol is branched, the crystallinity of the crystalline polyester resin decreases, and the melting point may decrease. Moreover, when the number of carbon atoms of the saturated aliphatic diol exceeds 12, it becomes difficult to obtain a practical material.

Examples of the saturated aliphatic diols include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. Among these saturated aliphatic diols, ethylene glycol, 1,4-butanediol, 1,6-hexanediol, 1,8-octanediol, 1,9-nonanediol, 1,10-decanediol, and 1,12-dodecanediol are preferable in that a crystalline polyester resin having high crystallinity and excellent sharp melting properties is obtained.

Examples of the trihydric or higher alcohol include, but are not limited to, glycerin, trimethylolethane, trimethylolpropane, and pentaerythritol. These alcohols may be used alone or in combination of two or more.

### ((Polyvalent Carboxylic Acid))

The polyvalent carboxylic acid is not particularly limited, and can be selected as appropriate according to the intended purpose. Examples of the polyvalent carboxylic acid include, but are not limited to, divalent carboxylic acids and trivalent or higher carboxylic acids.

Examples of the divalent carboxylic acid include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids such as phthalic acid, isophthalic acid, terephthalic acid, naphthalene-2,6-dicarboxylic acid, malonic acid, and mesaconic acid. Further examples include, but are not limited to, anhydrides of such divalent carboxylic acids and their lower (1 to 3 carbon atoms) alkyl esters. Among such divalent carboxylic acids, from the viewpoint of carbon neutrality, plant-derived saturated aliphatic fatty acids having 12 or fewer carbon atoms are preferable.

Examples of trivalent or higher carboxylic acids include, but are not limited to, 1,2,4-benzenetricarboxylic acid, 1,2,5-benzenetricarboxylic acid, 1,2,4-naphthalenetricarboxylic acid, and anhydrides and lower (1 to 3 carbon atoms) alkyl esters of such trivalent or higher carboxylic acids.

These alcohols may be used alone or in combination of two or more.

The crystalline polyester resin preferably includes a linear saturated aliphatic dicarboxylic acid having 4 to 12 carbon atoms, and a linear saturated aliphatic diol having 2 to 12 carbon atoms. As a result, the crystalline polyester resin has a high crystallinity and excellent sharp melting properties and can exert excellent low-temperature fixing properties. Furthermore, examples of methods of controlling the crystallinity and softening point of the crystalline polyester resin include, but are not limited to, a method of designing and using a non-linear polyester obtained by adding a trihydric or higher polyhydric alcohol, such as glycerin, to the alcohol component during polyester synthesis, or a trivalent or higher polycarboxylic acid, such as trimellitic anhydride, to the acid component, and then carrying out condensation polymerization.

The molecular structure of the crystalline polyester resin can be confirmed by an NMR measurement of a liquid or solid sample, and further, by X-ray diffraction, GC/MS, LC/MS, IR measurements, and the like. Examples of simple methods include, but are not limited to, detecting resins that display absorption at 965±10 cm⁻¹ and 990±10 cm⁻¹ due to δ_{CH} (out-of-plane bending vibration) of an olefin in the infrared absorption spectrum.

In terms of the molecular weight, crystalline polyester resins having a sharp molecular weight distribution and a low molecular weight have excellent low-temperature fixing properties. Further, a large amount of low-molecular weight components causes the heat-resistant storage stability to deteriorate. From such a viewpoint, it is preferable that, in the molecular weight distribution obtained by GPC of the o-dichlorobenzene soluble fraction, a molecular weight distribution diagram, in which the horizontal axis is log (M) and the vertical axis is mass %, has a peak position in a range of 3.5 to 4.0, a half width of the peak is 1.5 or less, a weight average molecular weight (Mw) is 3,000 to 30,000, a number average molecular weight (Mn) is 1,000 to 10,000, and a ratio Mw/Mn of the weight average molecular weight (Mw) to the number average molecular weight (Mn) is 1 to 10. It is more preferable that the weight average molecular weight (Mw) is 5,000 to 15,000, the number average molecular weight (Mn) is 2,000 to 10,000, and the value of Mw/Mn is 1 to 5.

The acid value of the crystalline polyester resin is preferably 5 mgKOH/g or more in order to achieve the desired low-temperature fixing properties from the viewpoint of the affinity between paper and the resin. In order to prepare fine particles by phase inversion emulsification, the acid value of the crystalline polyester resin is more preferably 7 mgKOH/g or more. On the other hand, in order to improve the hot offset resistance, the acid value of the crystalline polyester resin is preferably 45 mgKOH/g or less.

In addition, the hydroxyl value of the crystalline polyester resin is preferably from 0 to 50 mgKOH/g, and more preferably from 5 to 50 mgKOH/g, in order to achieve the predetermined low-temperature fixing properties and good charging characteristics.

The content of the crystalline polyester resin is not particularly limited, and can be selected as appropriate according to the intended purpose. The content is preferably 3 parts by mass to 15 parts by mass with respect to 100 parts by mass of the resin particle.

### [Other Components]

The resin particle further includes an external additive, and may include other components. Examples of other components include, but are not limited to, a release agent, a colorant, a charge control agent, a cleanability improver, and a magnetic material.

### (Release Agent)

The release agent is not particularly limited, and can be selected as appropriate according to the intended purpose. However, a release agent having a low melting point of 50° C. to 120° C. is preferable. As a result of dispersing a low melting point release agent in the resin, the release agent effectively acts as a release agent at the interface between a fixing roller and the resin particle, resulting in good hot offset properties even in an oil-less system (where a release agent such as oil is not applied to the fixing roller).

Preferable examples of the release agent include, but are not limited to, waxes. Examples of waxes include, but are not limited to, natural waxes including plant-based waxes such as carnauba wax, cotton wax, wood wax, and rice wax; animal-based waxes such as beeswax and lanolin; mineral-based waxes such as ozokerite and ceresin; and petroleum waxes such as paraffin wax, microcrystalline wax, and petrolatum wax. In addition to these natural waxes, examples of waxes include, but are not limited to, synthetic waxes including synthetic hydrocarbon waxes, such as Fischer-Tropsch wax and polyethylene wax, esters, ketones, and ethers. Also, fatty acid amide compounds such as 12-hydroxystearamide, stearamide, phthalimide anhydride, and chlorinated hydrocarbons; polyacrylate homopolymers or copolymers such as poly-n-stearyl methacrylate and poly-n-lauryl methacrylate (for example, n-stearyl acrylate-ethyl methacrylate copolymer), which are crystalline polymer resins having low molecular weight; and crystalline polymers having long alkyl groups in a side chain; may also be used as the wax. These waxes can be used alone or in combination of two or more.

Natural waxes are preferable from the viewpoint of reducing the environmental impact.

The melting point of the wax is not particularly limited, and can be selected as appropriate depending on the purpose. However, the melting point is preferably 50° C. to 120° C., and more preferably 60° C. to 90° C. When the melting point is 50° C. or higher, the wax can be prevented from adversely affecting the heat-resistant storage stability, and when the melting point is 120° C. or lower, the occurrence of cold offset can be effectively prevented during fixing at low temperatures. The melt viscosity of the wax, as measured at a temperature 20° C. higher than the melting point of the wax, is preferably 5 cps to 1,000 cps, and more preferably 10 cps to 100 cps. When the melt viscosity is 5 cps or more, deterioration of the releasability can be prevented, and when the melt viscosity is 1,000 cps or less, the effects of hot offset resistance and low-temperature fixing properties can be sufficiently exhibited. The content of the wax in the resin particle is not particularly limited, and can be selected as appropriate according to the intended purpose. However, the content is preferably 0% by mass to 40% by mass, and more preferably 3% by mass to 30% by mass.

### (External Additives)

As the external additive, inorganic fine particles, polymer fine particles, and the like, can be used. The external additive includes at least two types of particles, namely fine particles A having an average particle size of 100 nm or more, and fine particles B having an average particle size of 10 to 50 nm, and the content ratio (i.e., mass ratio) A/B of the fine particles A to the fine particles B is 0.5 to 1.4. The average particle size is the average particle size of the primary particles.

Examples of inorganic fine particles include, but are not limited to, silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, Bengala, antimony trioxide, magnesium oxide, zirconium oxide, barium sulfate, barium carbonate, calcium carbonate, silicon carbide, and silicon nitride. Among these inorganic fine particles, silica, alumina, and titanium oxide are preferable.

Furthermore, the inorganic fine particles may be subjected to surface treatment with a hydrophobic treatment agent to enhance hydrophobicity, and to prevent deterioration of the flow characteristics and charging characteristics, even under high humidity conditions. Examples of preferable hydrophobic treatment agents include, but are not limited to, silane coupling agents, silylation agents, silane coupling agents having an alkyl fluoride group, organic titanate-based coupling agents, aluminum-based coupling agents, silicone oils, and modified silicone oils.

Examples of the polymer fine particles include, but are not limited to, polystyrene, methacrylate ester, and acrylic ester copolymers obtained by soap-free emulsion polymerization, suspension polymerization, and dispersion polymerization, polycondensation systems such as silicone, benzoguanamine, and nylon, and polymer particles formed of thermosetting resins.

In addition, in terms of the average particle size of the external additive, the average particle size of the fine particles A is 100 nm or more, preferably 150 nm or more, and more preferably the upper limit is 300 nm or less. The average particle size of the fine particles B is 10 to 50 nm, and is preferably 20 nm to 30 nm. When the average particle size of the fine particles A is 100 nm or more, a filler effect provides improved heat-resistant storage stability. When the average particle size of the fine particles B is 10 nm or more, aggregation of the external additive is prevented, and the external additive can be uniformly dispersed in the resin particle.

Note that the average particle size is a value obtained by directly calculating the particle diameter from a photograph obtained by a transmission electron microscope, and it is preferable to observe at least 100 particles and use the average value of the major axis.

The specific surface area of the external additive as measured by the BET method is preferably 20 to 500 m²/g.

The content of the external additive is preferably 0.01% by mass to 5% by mass of the resin particle. Furthermore, as described above, the content ratio (i.e., mass ratio) A/B of the fine particles A to the fine particles B is 0.5 to 1.4, and more preferably 0.7 to 1.2. Particles that include a PET or PBT component have a high charge and a high hygroscopicity, which can cause problems with respect to the image quality, such as reduced particle transportability and cleaning properties. In the relationship between the external additives A and B, when A/B is 0.5 or more, excessive charging properties can be prevented, and when A/B is 1.4 or less, the particle powder properties such as transportability can be improved.

### (Colorant)

As the colorant, known dyes and pigments can be used. Examples of the colorant include, but are not limited to, carbon black, nigrosine dye, iron black, Naphthol Yellow S, Hansa Yellow (10G, 5G, G), Cadmium Yellow, yellow iron oxide, ocher, chrome yellow, titanium yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, Isoindolinone Yellow, red iron oxide, red lead, lead vermilion, Cadmium Red, Cadmium-Mercury Red, antimony vermilion, Permanent Red 4R, Para Red, Faise Red, Para-chloro ortho nitroaniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubin B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazo Red, Chrome Vermilion, Benzidine Orange, Perinone Orange, Oil Orange, Cobalt Blue, Cerulean Blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), indigo, ultramarine blue, Prussian blue, Anthraquinone Blue, Fast Violet B, Methyl Violet Lake, cobalt violet, manganese violet, Dioxane Violet, Anthraquinone Violet, Chrome Green, Zinc Green, chromium oxide, viridian, Emerald Green, Pigment Green B, Naphthol Green B, Green Gold, Acid Green Lake, Malachite Green Lake, Phthalocyanine Green, Anthraquinone Green, titanium oxide, zinc white, and lithopone, and mixtures thereof.

### (Charge Control Agent)

Typical charge control agents can be used as the charge control agent. Examples of the charge control agent include, but are not limited to, nigrosine-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, elemental phosphorus or phosphorus compounds, elemental tungsten or tungsten compounds, fluorine-based activators, metal salts of salicylic acid, and metal salts of salicylic acid derivatives. Specific examples of the charge control agent include, but are not limited to, a nigrosine-based dye BONTRON 03, a quaternary ammonium salt BONTRON P-51, a metal-containing azo dye BONTRON S-34, an oxynaphthoic acid-based metal complex E-82, a salicylic acid-based metal complex E-84, a phenolic condensate E-89 (all manufactured by Orient Chemical Industries Co., Ltd.), quaternary ammonium salt molybdenum complexes TP-302 and TP-415 (both manufactured by Hodogaya Chemical Co., Ltd.), a quaternary ammonium salt copy charge PSY VP2038, a triphenylmethane derivative copy blue PR, a quaternary ammonium salt copy charge NEG VP2036, and a copy charge NX VP434 (all manufactured by Hoechst AG), LRA-901 and a boron complex LR-147 (manufactured by Japan Carlit Co., Ltd.), copper phthalocyanine, perylene, quinacridone, azo pigments, and in addition, polymeric compounds having functional groups such as sulfonic acid groups, carboxyl groups, and quaternary ammonium salts. The charge control agent may be used in an amount within a range that enables the performance to be exhibited without interfering with the fixing properties and the like, and is included in the resin particle in an amount of 0.5% by mass to 5% by mass, and preferably 0.8% by mass to 3% by mass.

### (Cleanability Improver)

The cleanability improver is not particularly limited as long as it is added to the resin particle to remove the developer remaining on a photoconductor and a primary transfer medium after transfer, and can be selected as appropriate according to the intended purpose. Examples of the cleanability improver include, but are not limited to, fatty acid metal salts such as zinc stearate, calcium stearate, and stearic acid, and polymer fine particles prepared by soap-free emulsion polymerization, such as polymethyl methacrylate fine particles, and polystyrene fine particles. The polymer fine particles preferably have a relatively narrow particle size distribution, and the volume average particle diameter is preferably 0.01 μm to 1 μm.

### (Magnetic Material)

The magnetic material is not particularly limited, and can be selected as appropriate from known materials according to the intended purpose. Examples of the magnetic material include, but are not limited to, iron powder, magnetite, and ferrite. Among these magnetic materials, white materials are preferable in terms of the color tone.

### <Characteristics of Resin Particle>

### [Particle Size of Resin Particle]

The particle size of the resin particle is measured using a Coulter Multisizer III (manufactured by Coulter Inc.). The particle size of the resin particle can be measured as follows. First, 2 mL of a surfactant (sodium dodecylbenzenesulfonate, manufactured by Tokyo Chemical Industry Co., Ltd.) is added as a dispersant to 100 mL of an electrolytic solution. The electrolytic solution is an approximately 1% aqueous NaCl solution prepared using first-grade sodium chloride, and ISOTON-II (manufactured by Coulter Inc.) can be used. Then, 10 mg of the measurement sample in solid form is added to a mixture of the electrolytic solution and the surfactant to obtain an electrolyte solution in which the sample is suspended. The electrolytic solution with the sample suspended therein is subjected to dispersion treatment in an ultrasonic disperser for about 1 to 3 minutes. Then, the volume and number of resin particle are measured using a Coulter Multisizer III with a 100 μm aperture, and the volume distribution and number distribution are calculated. The volume average particle size (Dv) of the resin particle is determined from the obtained distribution.

### [Measurement Method of Melting Point and Glass Transition Temperature (Tg)]

The melting point and the glass transition temperature (Tg) of the resin particle can be measured, for example, by using a differential scanning calorimeter (DSC) system (“Q-200”, manufactured by TA Instruments). Specifically, the melting point and the glass transition temperature of the target sample can be measured by the following procedure. First, about 5.0 mg of a target sample is placed in a sample container made of aluminum, and the sample container is placed on a holder unit and set in an electric furnace. Then, under a nitrogen atmosphere, the sample is heated from −80° C. to 150° C. at a ramp rate of 10° C./min (first temperature ramp). Next, the sample is cooled from 150° C. to −80° C. at a cooling rate of 10° C./min, and heated again to 150° C. at a ramp rate of 10° C./min (second temperature ramp). In each of the first temperature ramp and the second temperature ramp, a DSC curve is measured by using a differential scanning calorimeter (“Q-200”, manufactured by TA Instruments). From the obtained DSC curves, the DSC curve obtained during the first temperature ramp can be selected by using the analysis program in the Q-200 system, to determine the glass transition temperature (Tg) of the target sample during the first temperature ramp. Similarly, the DSC curve during the second temperature increase can be selected to determine the glass transition temperature (Tg) of the target sample during the second temperature ramp.

Also, from the obtained DSC curves, the DSC curve obtained during the first temperature ramp can be selected by using the analysis program in the Q-200 system to determine the endothermic peak top temperature in the first temperature ramp of the target sample as the melting point. Similarly, the DSC curve obtained during the second temperature increase can be selected to determine the endothermic peak top temperature during the second temperature ramp of the target sample as the melting point.

Furthermore, herein, in terms of the glass transition temperatures (Tg) and melting points of the amorphous polyester resin A, the amorphous polyester resin B, the crystalline polyester resin C, and other components such as the release agent, unless otherwise specified, the endothermic peak top temperature and the glass transition temperature (Tg) obtained during the second temperature ramp, is used as the melting point and the glass transition temperature (Tg) of each target sample.

### [Average Particle Size, Average Circularity]

The average particle size and the average circularity can be measured using, for example, a flow type particle image analyzer (FPIA-3000, manufactured by Sysmex Corporation). In a specific measurement method, 0.1 mL to 0.5 mL of a surfactant, preferably an alkylbenzene sulfonate, is added as a dispersant to a container containing 100 mL to 150 mL of water from which solid impurities have been removed in advance, and then about 0.1 g to 0.5 g of the measurement sample is added thereto. The suspension in which the sample is dispersed is subjected to dispersion treatment for about 1 to 3 minutes using an ultrasonic disperser, and the average particle size and average circularity are measured using a flow type particle image analyzer with the dispersion liquid concentration being 3,000 particles/μL to 10,000 particles/μL. Note that the particle size represents the equivalent circular diameter, and the average particle size is calculated based on the equivalent circular diameter (number basis). The analysis conditions for the flow type particle image analyzer are as follows.
Particle size limit: 0.5 μm≤equivalent circular diameter (number basis)≤200.0 μm
Particle shape limit: 0.93<circularity≤1.00

The average circularity is defined as follows.

(Average circularity)=(Perimeter of circle equal to the projected area)/(Perimeter of the projected image)

### [Measurement of Molecular Weight]

The molecular weight of each constituent component of the resin particle can, for example, be measured by the following method.
Gel permeation chromatography (GPC) measurement device: GPC-8220GPC (manufactured by Tosoh Corporation)
Column: TSKgel Super HZM-H 15 cm triple column (manufactured by Tosoh Corporation)
Temperature: 40° C.
Solvent: THF
Flow rate: 0.35 mL/min
Sample: Injection of 100 μL of 0.15% by mass sample
Pretreatment of sample: 0.15% by mass of the resin particle is dissolved in tetrahydrofuran (THF containing a stabilizer, manufactured by Wako Pure Chemicals, Ltd.), and then filtered through a 0.2 μm filter. The filtrate is used as the sample. The measurement is performed by injecting 100 μL of the THF sample solution.

In measuring the molecular weight of the sample, the molecular weight distribution of the sample is calculated from the relationship between the count number and the logarithmic value of a calibration curve prepared by using several types of monodispersed polystyrene standard samples. SHODEX STANDARD No. S-7300, S-210, S-390, S-875, S-1980, S-10.9, S-629, S-3.0, and S-0.580 manufactured by Showa Denko K.K. are used as polystyrene standard samples for preparing the calibration curve. A refractive index (RI) detector is used as the detector.

### <Method of Manufacturing Resin Particle>

The method of manufacturing the resin particle will be described. The method of manufacturing the resin particle includes an oil phase preparation step, an aqueous phase preparation step, a phase inversion emulsification step, a solvent removal step, an aggregation step, and a fusion step, and if preferable, additional steps such as a shell formation step, a washing step, a drying step, an annealing step, and an external addition step.

### (Oil Phase Preparation Step)

In the oil phase preparation step, first, the raw materials of the resin particle, namely the resins (the amorphous resin, the non-crystalline resin, the crystalline resin, and the like), PET or PBT, and, if preferable, materials such as a colorant, a prepolymer (the precursor of the amorphous polyester resin A), a wax, and the like, are dissolved or dispersed in an organic solvent to prepare the oil phase. Note that some of the materials may be added during the aggregation step described later.

The preparation method of the oil phase is not particularly limited, and can be selected as appropriate according to the intended purpose. Examples of the preparation method include, but are not limited to, a method in which the raw materials such as the resins are gradually added to an organic solvent with stirring to dissolve or disperse the raw materials.

The dispersion can be performed using known dispersing machines, such as a bead or a disk mill.

The raw materials used in the oil phase preparation step can be those described above under the heading <Resin Particle>. The raw materials may be used alone, or in combination of two or more types.

The organic solvent is not particularly limited, and can be selected according as appropriate according to the intended purpose, but is preferably a volatile organic solvent having a boiling point of less than 100° C. from the viewpoint of ease of subsequent removal of the organic solvent.

Examples of such an organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, and isopropyl alcohol. The organic solvent may be used alone, or in combination of two or more types.

When the resin to be dissolved or dispersed in the organic solvent is a resin having a polyester backbone, the organic solvent is preferably an ester-based solvent such as methyl acetate, ethyl acetate, or butyl acetate, or a ketone-based solvent such as methyl ethyl ketone or methyl isobutyl ketone, because of the high solubility. Among these solvents, the organic solvent is preferably methyl acetate, ethyl acetate, or methyl ethyl ketone, which have high solvent removability.

The amount of the organic solvent used is not particularly limited, and can be selected as appropriate according to the intended purpose. However, the amount of the organic solvent is preferably 40 parts by mass to 300 parts by mass, more preferably 60 parts by mass to 140 parts by mass, and even more preferably 80 parts by mass to 120 parts by mass with respect to 100 parts by mass of the raw materials of the resin particle.

### (Aqueous Phase Preparation Step)

In the aqueous phase preparation step, an aqueous phase (also referred to as “aqueous medium”) is prepared.

The aqueous medium is not particularly limited, and can be selected as appropriate from known media. Examples of the aqueous medium include, but are not limited to, water, a solvent miscible with water, or a mixture thereof. From the viewpoint of the granulation properties, the concentration of the water-miscible solvent is preferably less than or equal to the saturation concentration in the ion-exchanged water used in the phase inversion emulsification step.

The water-miscible solvent is not particularly limited, and can be selected as appropriate from among known solvents. Examples of the water-miscible solvent include, but are not limited to, alcohols, dimethylformamide, tetrahydrofuran, cellosolves, lower ketones, and esters.

Examples of the alcohol include, but are not limited to, methanol, isopropanol, and ethylene glycol.

Examples of lower ketones include, but are not limited to, acetone and methyl ethyl ketone.

Examples of esters include, but are not limited to, ethyl acetate.

These solvents may be used alone or in combination of two or more types.

### (Phase Inversion Emulsification Step)

In the phase inversion emulsification step, the oil phase obtained in the oil phase preparation step is processed into fine particles.

After neutralizing the oil phase, ion-exchanged water is added to the neutralized oil phase, and a fine particle dispersion liquid is obtained by phase inversion emulsification, in which the water-in-oil dispersion liquid is inverted into an oil-in-water dispersion liquid.

The phase inversion emulsification is carried out by stirring.

The phase inversion emulsification is carried out by uniform mixing and dispersion using a conventional stirrer or dispersion device.

The stirring blade is not particularly limited, and can be selected as appropriate according to the viscosity of the solution. Examples of the stirring blade include, but are not limited to, low viscosity stirring blades such as paddles and propellers, medium viscosity stirring blades such as anchor blades and MAXBLEND®, and high viscosity stirring blades such as helical ribbons.

The dispersion device is not particularly limited, and examples thereof include, but are not limited to, an ultrasonic disperser, a bead mill, a ball mill, a roll mill, a HOMOMIXER, an ultra mixer, a disperser mixer, a penetrating high pressure dispersion device, a collision high pressure dispersion device, a multi-hole high pressure dispersion device, an ultra-high pressure homogenizer, and an ultrasonic homogenizer. A conventional stirrer and dispersion device may be used in combination.

Among stirring blades, paddles and anchor blades are preferable because it is possible to control the volume average particle size of the dispersion (oil droplets) within the preferable ranges mentioned above.

As the base for neutralizing the oil phase, either a basic inorganic compound or a basic organic compound may be used. Examples of basic inorganic compounds include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

When the stirring blade is used, conditions such as the rotation speed, the stirring time, and the stirring temperature are not particularly limited, and can be selected as appropriate according to the intended purpose.

The rotation speed is not particularly limited, but is preferably 100 rpm to 1,000 rpm, and more preferably 200 rpm to 600 rpm.

The stirring time and the stirring temperature are not particularly limited, and may be selected as appropriate according to the intended purpose.

Furthermore, a dispersant may be used if preferable. The dispersant is not particularly limited, and can be selected as appropriate according to the intended purpose. Examples of the dispersant include, but are not limited to, surfactants, inorganic compound dispersants that are poorly soluble in water, and polymer-based protective colloids. These dispersants may be used alone or in combination of two or more types. Among these dispersants, surfactants are preferable.

The surfactant is not particularly limited, and can be selected as appropriate according to the intended purpose. For example, anionic surfactants, cationic surfactants, nonionic surfactants, and amphoteric surfactants can be used.

The anionic surfactant is not particularly limited, can be selected as appropriate according to the intended purpose, and examples thereof include, but are not limited to, alkylbenzene sulfonate, α-olefin sulfonate, and phosphoric acid ester. Among these anionic surfactants, surfactants having a fluoroalkyl group are preferable.

### (Solvent Removal Step)

In the solvent removal step, the organic solvent is removed from the obtained fine particle dispersion.

In order to remove the organic solvent from the obtained fine particle dispersion, it is possible to adopt a method in which the temperature is gradually raised while stirring the entire system, and then completely removing the organic solvent in the droplets by evaporation.

Alternatively, the organic solvent in the droplets can be completely removed by spraying the obtained fine particle dispersion into a dry atmosphere while stirring. In addition, the organic solvent may be evaporated and removed by reducing the pressure while stirring the fine particle dispersion. Alternatively, the organic solvent may be evaporated and removed by blowing gas onto the fine particle dispersion while stirring.

These methods may be used alone or in combination.

The drying atmosphere into which the fine particle dispersion is sprayed generally includes heated air, nitrogen, carbon dioxide, combustion gas, and the like. In particular, various air streams heated to a temperature greater than or equal to the boiling point of the highest boiling point solvent are used. The target quality can be sufficiently obtained by treatment for a short time using a spray dryer, a belt dryer, a rotary kiln, or the like.

By removing the organic solvent from the fine particle dispersion obtained by the above method, a fine particle dispersion liquid can be obtained.

### (Aggregation Step)

In the aggregation step, aggregated particles are obtained by stirring the obtained fine particle dispersion liquid to aggregate the particles until a desired particle size is obtained.

In order to induce the aggregation, existing methods such as addition of a flocculant, pH adjustment, and the like, can be used. When a flocculant is added, the flocculant may be added as is. However, it is preferable to add the flocculant in the form of an aqueous solution, since localized high concentrations can be avoided. It is also preferable to add the flocculant gradually while monitoring the particle size of the fine particles.

The temperature of the dispersion liquid during aggregation is preferably near the glass transition temperature Tg of the resin that is used. If the liquid temperature of the fine particle dispersion liquid is too low, aggregation does not proceed very much, resulting in poor efficiency. If the liquid temperature of the fine particle dispersion liquid is too high, the aggregation rate increases, resulting in the generation of coarse particles and the like, resulting in deterioration of the particle size distribution.

Once the desired particle size is reached, the aggregation is stopped. As the method of stopping the aggregation, a method of adding a salt with a low ionic valence or a chelating agent, a method of adjusting the pH, a method of lowering the temperature of the dispersion liquid, a method of adding a large amount of an aqueous medium to dilute the concentration, and the like, can be used.

A dispersion liquid of resin particles can be obtained by the above methods.

In the aggregation step, a colorant, a crystalline resin, and a release agent may be added. In this case, the material is dispersed in a dispersion liquid in an aqueous medium, or mixed with the fine particle dispersion liquid described above, and then aggregated to obtain aggregated particles in which the colorant, crystalline resin, and release agent are uniformly dispersed.

In the present embodiment, it is preferable to use a Na metal salt, which has a low ionic valence. By replacing the metal used as the flocculant with Na, flocculation can be efficiently stopped.

### ((Flocculant))

Typical flocculants can be used as the flocculant. The flocculant may be used alone or in combination of two or more.

The metal ions function as a crosslinking agent that crosslinks the end portions of the resin.

For example, metal salts of monovalent metals such as sodium and potassium, metal salts of divalent metals such as calcium and magnesium, and metal salts of trivalent metals such as iron and aluminum can be used.

In the present embodiment, in order to obtain resin particles with a good particle size distribution, a divalent metal salt is preferable.

The crosslinking effect is low when a monovalent metal is used. In addition, when using a biomass resin, a non-crystalline resin having many aromatic ring backbones, and a PET or PBT resin, the difference in structure is large, and if a trivalent or higher metal salt having a fast crosslinking reaction rate is used, the particle size distribution of the resin particles will become poor. Among the divalent metals, Mg exhibits particularly good aggregation. If the metal used in the flocculant and the like remains in the resin particles, the charging properties will deteriorate. Therefore, the amount of the divalent metal element in the resin particles is set to 0.05% by mass to 1% by mass. When the amount of the element in the resin particles is 0.05% by mass or more, the amount of metal used during aggregation is sufficient, and the aggregation force is sufficient. Therefore, deterioration of the particle size distribution can be prevented. When the amount of the element in the resin particles is 1% by mass or less, the resin particles are provided with charging properties. The type and amount of metal in the resin particles can be adjusted by the type and amount of the flocculant and terminator, and the washing conditions in the washing step.

### (Fusion Step)

In the fusion step, the obtained aggregated particles are fused by heat treatment to reduce irregularities and to make the particles spherical. The fusion can be achieved by heating the dispersion liquid of the aggregated particles while stirring. The temperature of the liquid is preferably near a temperature above the glass transition temperature Tg of the resin used.

### (Shell Formation Step)

Furthermore, a shell formation step may be performed if preferable. In the shell formation step, a shell layer is formed on the spherical particles obtained in the fusion step.

The method of forming the shell layer is not particularly limited, and can be selected as appropriate according to the intended purpose. Examples of methods of forming the shell layer include, but are not limited to, a method in which a non-crystalline resin is added to spherical particles having a desired particle size that have been prepared in the fusion step, and then forming the shell layer by repeatedly performing the aggregation step and fusion step. In the present invention, it is preferable that the base particles have a core-shell structure, and the shell portion includes polyethylene terephthalate or polybutylene terephthalate.

### (Washing and Drying Steps)

In the washing and drying steps, only the resin particles are taken out from the resin particle dispersion liquid obtained by the method described above, and then the resin particles are washed and dried.

The resin particle dispersion liquid obtained by the above method contains secondary materials such as flocculant salts in addition to the resin particles. Therefore, the washing is carried out in order to extract only the resin particles from the dispersion liquid. The washing method of the resin particles includes, but is not limited to, centrifugation, reduced pressure filtration, and filter pressing. Any of the methods above will produce a cake of resin particles. However, if sufficient washing cannot be achieved in a single operation, the obtained cake may be dispersed again in an aqueous solvent to form a slurry, and the step of extracting the resin particles by any of the above methods may be repeated. Alternatively, if the washing is performed by reduced pressure filtration or filter pressing, a method may be adopted in which an aqueous solvent is passed through the cake to wash away the secondary materials absorbed by the colored resin particles. The aqueous solvent used in the washing is water, or a mixed solvent of water and an alcohol such as methanol or ethanol. From the viewpoint of cost, environmental impact due to wastewater treatment, and the like, it is preferable to use water.

Because the washed resin particles contain a large amount of the aqueous medium, the aqueous medium can be removed by drying to obtain only the resin particles.

As the drying method, a dryer such as a spray dryer, a vacuum freeze dryer, a reduced pressure dryer, a stationary shelf dryer, a movable shelf dryer, a fluidized bed dryer, a rotary dryer, or an agitator dryer can be used. The dried resin particle are preferably dried until the water content is finally reduced to less than 1%. In addition, the colored resin particle after drying are in the form of soft aggregates. In the case where the resin particle are inconvenient to use, the soft agglomerates may be broken up by crushing the resin particle using an apparatus such as a jet mill, a HENSCHEL MIXER, a SUPER MIXER, a coffee mill, an OSTER blender, or a food processor.

### (Annealing Step)

In the annealing step, when a crystalline resin is added, by performing annealing treatment after drying, the amorphous resin and the crystalline resin undergo phase separation, which improves the fixing properties. Specifically, the material may be stored at a temperature near the glass transition temperature Tg for 10 hours or more.

The base particles in the resin particles obtained as described above preferably have a BET specific surface area of 0.8 to 1.4 m²/g. A BET specific surface area of 0.8 m²/g or more is advantageous in terms of controlling the amount of charge. A BET specific surface area of 1.4 m²/g or less is advantageous in terms of the fluidity and cleaning properties. The BET specific surface area is more preferably 1.0 to 1.2 m²/g. The BET specific surface area can be adjusted by adjusting the temperature and time of the fusion step in the particle manufacturing step.

The BET specific surface area can be measured, for example, by an automatic specific surface area/pore distribution measurement device (TriStar 3000, manufactured by Shimadzu Corporation). Specifically, about 0.5 g of the toner is weighed into a sample cell, and the toner is vacuum-dried for 24 hours using a pretreatment SmartPrep (manufactured by Shimadzu Corporation) to remove impurities and water from the sample surface. The pretreated sample is set in the automatic specific surface area/pore distribution measurement device (TriStar 3000: manufactured by Shimadzu Corporation) to determine the relationship between the nitrogen gas adsorption amount and the relative pressure, and the BET specific surface area of the toner is determined from the relationship between the nitrogen gas adsorption amount and the relative pressure by the BET multipoint method.

### (External Addition Step)

In order to impart fluidity, charging properties, cleaning properties, and the like, to the base particles of the obtained resin particles, external additives may be attached to the base particles, and other additives, such as a wax, a colorant, a charge control agent, and a cleanability improver, may also be added and mixed.

Specific mixing methods include, but are not limited to, a method in which an impact force is applied to the mixture by a blade rotating at high speed, and a method in which the mixture is introduced into a high-speed air current and accelerated, such that the particles collide with each other or the composite particles collide with a suitable collision plate.

Examples of such devices include, but are not limited to, an ONG MILL (manufactured by Hosokawa Micron Corporation), a modified I-type Mill (manufactured by Japan Pneumatic Co., Ltd.) with reduced grinding air pressure, a hybridization system (manufactured by Nara Machinery, Ltd.), a CRTPTRON system (manufactured by Kawasaki Heavy Industries Co., Ltd.), and an automatic mortar.

The resin particles preferably have a radioactive carbon isotope ¹⁴C concentration of 10.8 pMC or more, and includes 0.05% by mass to 1% by mass of divalent metal elements, excluding the external additives included in the resin particles. Because the resin particles includes PET or PBT, even when the resin particles include a biomass-derived resin instead of a petroleum-derived resin, the effect of structural differences in the biomass-derived resin on the properties of the can be reduced while also making the resin particles more environmentally friendly. Furthermore, because the resin particles include 0.05% by mass to 1% by mass of a divalent metal element, when the resin particles are aggregated using a metal salt during manufacturing of the resin particles, the resin particles can be aggregated under mild conditions, which enables resin particles to be obtained that have a good particle size distribution.

Therefore, the resin particles are capable of reducing the environmental impact while also having an excellent particle size distribution, and can form images having excellent image quality.

The resin particle includes at least one of an amorphous resin, a non-crystalline resin, and a crystalline resin, and at least one of the amorphous resin, the non-crystalline resin, and the crystalline resin contains a biomass-derived resin, and the total content of the biomass-derived resin and PET or PBT relative to the total mass of the resin particle can be 50% by mass or more. As a result, the resin particle includes a biomass-derived resin, which enhances environmental friendliness, while also reliably reducing the impact of the structural differences between biomass-derived resins and petroleum-derived resins on the properties of the resin particle. Therefore, the resin particle can improve the particle size distribution and more stably provide images having excellent quality, while also reducing the environmental impact.

The resin particle can include more PET or PBT than the biomass-derived resin. As a result, the resin particle can further reduce the impact of the structural differences between biomass-derived resins and petroleum-derived resins on the properties of the resin particle.

The resin particle can include 0.1% by mass to 0.5% by mass of magnesium among the divalent metal elements. As a result, when the resin particles are aggregated using a metal salt during the manufacturing of the resin particles, the resin particles can be more reliably aggregated together under mild conditions. Therefore, it is possible to reliably obtain resin particles having an even better particle size distribution.

The resin particle can include sodium, and among the divalent metal elements, contain more magnesium than sodium, and the sodium content can be more than 0.05% by mass. As a result, when the resin particles are aggregated using a metal salt during the manufacturing of the resin particles, the aggregation of the resin particles with each other can be performed under even milder conditions. Therefore, it is possible to reliably obtain resin particles having an even better particle size distribution.

Because the resin particle has the properties described above, the resin particle can be effectively used as an image forming material in a toner, a developer, a toner set, a toner storage unit, an image forming apparatus, or the like.

### <Toner>

The toner according to an embodiment includes the resin particle according to an embodiment, and may be made of the resin particle according to an embodiment.

As a result of using the resin particle in a toner, the environmental impact is reduced. Further, even when a plant-derived resin is used, excellent low-temperature fixing properties and charging properties, and images having excellent image quality can be provided.

### <Developer>

The developer according to an embodiment contains the toner according to an embodiment, and if preferable, may contain other components, such as a carrier, which have been selected as appropriate. This allows the toner to have excellent transferability, charging properties, and the like, and to stably form high-quality images.

The developer may be a single-component developer or a two-component developer. However, the developer is preferably a two-component developer from the perspective of improving the life-span when used in a high-speed printer or the like that is compatible with recent improvements in information processing speed.

When the toner is used in a single-component developer, even if the toner is consumed and supplied, there is little variation in the particle size of the toner, and toner filming on a developing roller and toner adhesion to components such as a blade that thins the toner layer are reduced, resulting in high-quality images being obtained in the developing device.

When the developer is used in a two-component developer, the developer can be mixed with a carrier, and the mixture used as the developer. When the toner is used as a two-component developer, even when the toner is balanced over a long period of time, there is little variation in the particle size of the toner, and good and stable development properties and images can be obtained even with long-term stirring in the developing device.

As a development method, a premix development method may be adopted, in which a premix developer including a toner and carrier that are mixed together in advance is replenished. In the premix development method, the excess carrier in the developing device is discharged as surplus developer. This gradually refreshes the developer in the developing device. Therefore, it is possible to extend the replacement cycle of the developer due to deterioration, and to eliminate the trouble of replacing the developer.

The content of the carrier in the two-component developer can be selected as appropriate according to the intended purpose, and is preferably 90 mass parts to 98 mass parts, and more preferably 93 mass parts to 97 mass parts relative to 100 mass parts of the two-component developer.

The developer can be preferably used in image formation by various known electrophotographic methods, such as the magnetic single-component development method, the non-magnetic single-component development method, and the two-component development method.

### [Carrier]

The carrier is not particularly limited and can be selected as appropriate according to the intended purpose. However, it is preferable that the carrier has a core material and a resin layer (coating layer) that coats the core material.

### (Core Material)

The material of the core material is not particularly limited, and can be selected as appropriate according to the intended purpose. Examples of the material include, but are not limited to, manganese-strontium based materials exhibiting 50 emu/g to 90 emu/g, and manganese-magnesium based materials exhibiting 50 emu/g to 90 emu/g. Furthermore, to ensure image density, it is preferable to use a highly magnetized material such as iron powder exhibiting 100 emu/g or more, or magnetite exhibiting 75 emu/g to 120 emu/g. Moreover, it is preferable to use a weakly magnetized material such as a copper-zinc material exhibiting 30 emu/g to 80 emu/g, because it is possible to alleviate the impact caused by a developer in an upright state with respect to a photoconductor, which is advantageous for obtaining a high image quality. These core materials may be used alone or in combination of two or more types.

The volume average particle size of the core material is not particularly limited, and can be selected as appropriate according to the intended purpose. However, the volume average particle size is preferably 10 μm to 150 μm, and more preferably 40 μm to 100 μm. If the volume average particle size is 10 μm or more, it is possible to effectively prevent a problem in which the amount of fine powder in the carrier increases, and the magnetization per particle decreases and causes the carrier to scatter. On the other hand, if the volume average particle size is 150 μm or less, it is possible to effectively prevent a problem in which the specific surface area decreases and results in scattering of the toner, and in the case of a full-color image having many solid areas, the reproduction of the solid portions becoming particularly poor.

### (Resin Layer)

The resin layer includes a resin and other components, if preferable. The resin used in the resin layer may be any known material capable of imparting the required charging properties. Specifically, it is preferable to use a silicone resin, an acrylic resin, or a combination of these resins. The composition for forming the resin layer preferably includes a silane coupling agent.

The average thickness of the resin layer is preferably 0.05 to 0.50 μm.

### <Developer Storage Container>

The developer storage container according to an embodiment accommodates the developer according to an embodiment. The developer storage container is not particularly limited, and can be selected as appropriate from among known containers. Examples of the developer storage container include, but are not limited to, a container having a container body and a cap.

In addition, the size, shape, structure, material, and the like, of the container body are not particularly limited. However, the shape is preferably a cylindrical shape or the like, and particularly preferably a shape in which spiral-shaped irregularities are formed on an inner circumferential surface such that, when the container body is rotated, enables the developer that is inside the container body to move to the discharge port side, and a part or all of the spiral-shaped irregularities have a bellows function. Further, the material is not particularly limited, but it is preferable that the material has good dimensional accuracy. Examples of the material include, but are not limited to, resin materials such as polyester resins, polyethylene resins, polypropylene resins, polystyrene resins, polyvinyl chloride resins, polyacrylic acid, polycarbonate resins, ABS resins, and polyacetal resins.

The developer storage container can be easily stored, transported, and the like, and has excellent handling properties. Therefore, the developer storage container can be attached to, and detached from, the image forming apparatus described below, a process cartridge, and the like, and can be used to replenish the developer.

### <Toner Storage Unit>

The toner storage unit according to an embodiment accommodates the toner according to an embodiment. The toner storage unit refers to a unit in which a toner is accommodated inside a unit having the function of accommodating the toner. Examples of the form of the toner storage unit include, but are not limited to, a toner storage container, a developing device, and a process cartridge.

The toner storage container refers to a container that accommodates a toner.

The developing device refers to a device having means of accommodating a toner and performing development.

The process cartridge refers to a cartridge in which at least an electrostatic latent image bearer (also referred to as an image bearer) and a developing device are integrally formed, that accommodates a toner, and is attachable to, and detachable from, an image forming apparatus. The process cartridge may further include at least one member selected from a charging device, an exposure device, and a cleaning device.

The toner storage unit according to an embodiment accommodates the toner according to an embodiment. As a result of attaching the toner storage unit to an image forming apparatus and forming an image, because the image is formed using the toner according to an embodiment, it is possible to obtain a toner having excellent low-temperature fixing properties and charging properties, and a high image quality.

### <Image Forming Apparatus>

The image forming apparatus according to an embodiment includes an electrostatic latent image bearer, an electrostatic latent image forming device that forms an electrostatic latent image on the electrostatic latent image bearer, a developing device that develops the electrostatic latent image that has been formed on the electrostatic latent image bearer using a toner and forms a toner image, and other additional components, if preferable.

The image forming apparatus more preferably includes, in addition to the electrostatic latent image bearer, the electrostatic latent image forming device and the developing device mentioned above, a transfer device that transfers the toner image onto a recording medium, and a fixing device that fixes a transfer image that has been transferred onto the surface of the recording medium.

The toner according to an embodiment is used in the developing device. The toner image is preferably formed using a developer including the toner according to an embodiment and additionally other components, such as a carrier.

### (Electrostatic Latent Image Bearer)

The structure, size, and the like, of the electrostatic latent image bearer is not particularly limited, and can be selected as appropriate from among known electrostatic latent image bearers. The shape of the image bearer is not particularly limited, and can be selected as appropriate according to the intended purpose. Examples of the shape include, but are not limited to a drum shape, and a belt shape. The material of the image bearer is not particularly limited, and can be selected as appropriate according to the intended purpose. Examples of the material include, but are not limited to, inorganic photoconductors such as amorphous silicon and selenium, and organic photoconductors (OPC) such as polysilane and phthalopolymethine.

Examples of the organic photoconductor include, but are not limited to, a laminated photoconductor that has, on a support body such as an aluminum drum, a laminated structure in which a layer including an electric charge generating material, such as metal-free phthalocyanine or titanyl phthalocyanine, is dispersed in a binder resin (electric charge generating layer), and a layer including an electric charge transporting material dispersed in a binder resin (electric charge transporting layer) are stacked; and a single-layer photoconductor that has, on a support body, a photoconductive layer having a single-layer structure in which both an electric charge generating material and an electric charge transporting material are dispersed in a binder resin.

In the case of a single-layer photoconductor, a hole transport agent and an electron transport agent may be added to the photoconductive layer as charge transport materials.

In addition, an undercoat layer may be provided between the support body and the charge generation layer in the laminated structure, or the photoconductive layer in the single-layer photoconductor.

The shape of the electrostatic latent image bearer is not particularly limited, and can be selected as appropriate according to the intended purpose. However, a cylindrical shape is preferable. The outer diameter of the electrostatic latent image bearer having the cylindrical shape is not particularly limited, and can be selected as appropriate according to the intended purpose. However, the outer diameter is preferably 3 mm to 100 mm, more preferably 5 mm to 50 mm, and particularly preferably 10 mm to 30 mm.

### (Electrostatic Latent Image Forming Device)

The electrostatic latent image forming device is not particularly limited as long as the device forms an electrostatic latent image on an electrostatic latent image bearer, and can be selected as appropriate according to the intended purpose. The electrostatic latent image forming device includes a charger that uniformly charges the surface of the electrostatic latent image bearer, and an exposure device that exposes the surface of the electrostatic latent image bearer in an imagewise fashion.

The charger is not particularly limited, and can be selected as appropriate according to the purpose intended purpose. Examples of the charger include a contact charger including a conducting or semiconducting roll, a brush, a film, a rubber blade, and the like, and a non-contact charger using corona discharge of a corotron, a scorotron, or the like.

The shape of the charger may take any form, such as, in addition to a roller form, a magnetic brush or fur brush form, and can be selected according to the specification and form of the image forming apparatus.

The charger is preferably arranged in a contact or non-contact state in the electrostatic latent image bearer, and charges the surface of the electrostatic latent image bearer by superimposed application of DC and AC voltages. Moreover, the charger is preferably a charging roller arranged in a non-contact state close to the electrostatic latent image bearer via a gap tape, and charges the surface of the electrostatic latent image bearer by applying superimposed DC and AC voltages to the charging roller.

The charger is not limited to a contact charger. However, a contact charger is preferably used in that an image forming apparatus can be obtained that reduces the ozone generated in the charger.

The exposure device is not particularly limited as long as the device performs exposure in an imagewise fashion with respect to the images to be formed on the surface of the electrostatic latent image bearer that has been charged by the charger, and can be selected as appropriate according to the intended purpose. Examples of the exposure device include, but are not limited to, various exposure devices such as a copying optical system, a rod lens array system, a laser optical system, and a liquid crystal shutter optical system.

The light source used in the exposure device is not particularly limited, and can be selected as appropriate according to the intended purpose. Examples of the light source include light emitters in general, such as fluorescent lights, tungsten lamps, halogen lamps, mercury lights, sodium lights, light emitting diodes (LED), semiconductor lasers (LD), and electroluminescence (EL).

Furthermore, in order to only irradiate the light in a desired wavelength range, various filters such as a sharp cut filter, a band pass filter, a near-infrared cut filter, a dichroic filter, an interference filter, and a color temperature conversion filter, can be used.

Note that the exposure device may adopt a backlight system in which exposure is performed in an imagewise fashion from the back side of the electrostatic latent image bearer.

### (Developing Device)

The developing device is not particularly limited as long as the device is capable of developing the electrostatic latent image that has been formed on the electrostatic latent image bearer, and can be selected as appropriate according to the intended purpose. As the developing device, for example, it is possible to preferably use a device that accommodates the toner, and includes a developing device that is capable of applying the toner to the electrostatic latent image in a contact or non-contact manner, and is preferably a developing device that includes a toner-filled container and the like.

The developing device may be a single-color developing device or a multi-color developing device. Preferable examples of the developing device include, but are not limited to, a developing device including a stirring part that stirs the toner with friction to charge the toner, a magnetic field generation device fixed inside the developing device, and a developer carrier (such as a magnet roller) that is capable of rotating while carrying the developer containing the toner on the surface.

### (Transfer Device)

The transfer device preferably includes a primary transfer device that transfers a visible image onto an intermediate transfer body to form a combined transfer image, and a secondary transfer device that transfers the combined transfer image onto a recording medium. Note that the intermediate transfer body is not particularly limited, and can be selected as appropriate from known transfer bodies according to the intended purpose. Preferable examples of the intermediate transfer body include, but are not limited to, a transfer belt.

The transfer device (the primary transfer device and the secondary transfer device) preferably includes at least a transfer unit that separates and charges the visible image formed on the electrostatic latent image bearer (photoconductor) onto the recording medium side. A single transfer device may be provided, or two or more transfer devices may be provided.

Examples of the transfer unit include, but are not limited to, a corona transfer unit using corona discharge, a transfer belt, a transfer roller, a pressure transfer roller, and an adhesive transfer unit.

The recording medium is typically plain paper, but is not particularly limited as long as an unfixed image after development can be transferred onto the recording medium, and can be appropriately selected from known recording media (recording paper) according to the intended purpose. Further, a PET base for overhead projectors (OHP) and the like can also be used.

### (Fixing Device)

The fixing device is not particularly limited, and can be selected as appropriate according to the intended purpose, and is preferably a known heating and pressurizing device. Examples of the heating and pressurizing device include, but are not limited to, a combination of a heating roller and a pressure roller, and a combination of a heating roller, a pressure roller, and an endless belt.

The fixing device is preferably a heating and pressurizing device that has a heating body equipped with a heating generating body, a film in contact with the heating body, and a pressurizing member pressed against the heating body via the film, that is capable of performing thermal fixing by passing a recording medium, on which an unfixed image has been formed, between the film and the pressurizing member.

Generally, heating in the heating and pressurizing device is preferably performed at 80° C. to 200° C.

The surface pressure in the heating and pressurizing device is not particularly limited, and can be selected as appropriate according to the intended purpose. However, the surface pressure is preferably 10 N/cm² to 80 N/cm².

In the present embodiment, for example, a known optical fixing device may be used with, or instead of, the fixing device according to the intended purpose.

### (Other Devices)

The image forming apparatus according to an embodiment can additionally include, for example, a charge removal device, a cleaning device, a recycling device, and a control device.

### ((Charge Removal Device))

The charge removal device is not particularly limited as long as the device applies a charge removal bias to the electrostatic latent image bearer, and can be selected as appropriate from known charge removal devices. Preferable examples include, but are not limited to, a charge removal lamp.

### ((Cleaning Device))

The cleaning device may be any type of device that can remove the toner remaining on the electrostatic latent image bearer, and can be selected as appropriate from among known cleaners. Examples of the cleaning device include, but are not limited to, magnetic brush cleaners, electrostatic brush cleaners, magnetic roller cleaners, blade cleaners, brush cleaners, and web cleaners.

The image forming apparatus according to an embodiment includes the cleaning device, thereby improving the cleaning properties. That is, by controlling the adhesive force between the toner particles, the fluidity of the toner can be controlled, and the cleaning properties can be improved. Furthermore, by controlling the characteristics of the toner after degradation, it is possible to maintain excellent cleaning quality even under severe conditions such as under an extended lifetime, or high temperature and humidity conditions. In addition, because the external additive can be sufficiently liberated from the toner on the photoconductor, a deposition layer (dam layer) of the external additive can be formed on a cleaning blade nip portion, which enables high cleaning properties to be achieved.

### ((Recycling Device))

The recycling device is not particularly limited, and examples include, but are not limited to, a known transport device.

### (Control Device))

The control device is capable of controlling the operation of each of the devices described above. The control device is not particularly limited as long as the control device is capable of controlling the operation of each of the devices described above, and can be selected as appropriate according to the intended purpose. Examples of the control device include, but are not limited to, control instruments such as sequencers and computers.

The image forming apparatus according to an embodiment is capable of forming an image using the toner according to an embodiment. Therefore, the image forming apparatus is capable of reducing power consumption, and stably providing high-quality images.

### <Image Forming Method>

The image forming method according to an embodiment includes: an electrostatic latent image forming step of forming an electrostatic latent image on an electrostatic latent image bearer; and a developing step of developing the electrostatic latent image using a toner and forming a toner image, and other additional steps, if preferable. The image forming method can be preferably performed by the image forming apparatus described above. The electrostatic latent image forming step can be preferably performed by the electrostatic latent image forming device described above. The developing step can be preferably performed by the developing device described above. The other steps can be preferably performed by the other devices described above.

Furthermore, the image forming method according to an embodiment more preferably includes, in addition to the electrostatic latent image forming step and the developing step described above, a transfer step of transferring the toner image onto a recording medium, and a fixing step of fixing a transfer image that has been transferred onto the surface of the recording medium.

The toner according to an embodiment is used in the developing step. The toner image is preferably formed by a developer including the toner according to an embodiment and additionally other components, such as a carrier.

The electrostatic latent image forming step is a step of forming an electrostatic latent image on the electrostatic latent image bearer. The electrostatic latent image forming step includes a charging step of charging the surface of the electrostatic latent image bearer, and an exposure step of exposing the surface of the charged electrostatic latent image bearer to light and forming an electrostatic latent image. The charging can be performed, for example, by applying a voltage to the surface of the electrostatic latent image bearer using a charger. The exposure can be carried out, for example, by exposing the surface of the electrostatic latent image bearer in an imagewise fashion using the exposure device. The electrostatic latent image can be formed, for example, by uniformly charging the surface of the electrostatic latent image bearer, and performing exposure in an imagewise fashion, and can be performed by the electrostatic latent image forming device.

The developing step is a step of successively developing an electrostatic latent image using toners of a plurality of colors to form a visible image. The visible image can be formed, for example, by developing the electrostatic latent image with the toner described above, and can be performed by the developing device.

In the developing device, for example, the toner and the carrier are mixed and stirred, and the toner becomes charged by friction during the mixing and stirring. The particles are held in a raised state on the surface of a rotating magnet roller, and form a magnetic brush. Because the magnet roller is positioned near the electrostatic latent image bearer (photoconductor), a portion of the toner constituting the magnetic brush formed on the surface of the magnet roller moves to the surface of the electrostatic latent image bearer (photoconductor) by an electrical attractive force. Consequently, the electrostatic latent image is developed by the toner to form a visible image, which is formed of the toner, on the surface of the electrostatic latent image bearer (photoconductor).

The transfer step is a step of transferring the visible image onto a recording medium. In a preferable mode of the transfer step, an intermediate transfer body is used, and primary transfer of the visible image is performed onto the intermediate transfer body. Then, secondary transfer of the visible image is performed onto the recording medium. In a more preferable mode of the transfer step, the transfer step includes a primary transfer step of using a toner of two or more colors, or preferably using a full color toner, and transferring the visible image onto the intermediate transfer body to form a composite transfer image, and a secondary transfer step of transferring the composite transfer image onto the recording medium. The transfer can be performed, for example, by charging the electrostatic latent image bearer (photoconductor) using a transfer charger, and can be performed by the transfer device.

The fixing step is a step of fixing the visible image that has been transferred onto the recording medium using a fixing device, and may be performed each time transfer onto the recording medium is performed with respect to the developer of each color, or simultaneously after stacking the developer corresponding to each color.

The image forming method according to an embodiment may include, if preferable, other additional steps that have been selected as appropriate, and it is possible to include steps such as a charge removal step, a cleaning step, and a recycling step.

The charge removal step is a step of removing charge by applying a charge removal bias to the electrostatic latent image bearer, and can be preferably performed by the charge removal device.

The cleaning step is a step of removing the toner remaining on the electrostatic latent image bearer, and can be preferably performed by the cleaning device.

The recycling step is a step of recycling the toner that has been removed in the cleaning step to the developing device, and can be preferably performed by the recycling device.

The image forming method according to an embodiment is capable of forming an image using the toner according to an embodiment. Therefore, the image forming apparatus is capable of reducing power consumption, and stably providing high-quality images.

Here, an image forming apparatus according to an embodiment of the present invention will be described with reference to the drawings. Note that the present invention is not limited to the embodiment described below, and may be subjected to changes such as other embodiments, additions, modifications, and omissions within a scope conceivable for a person skilled in the art. Each of the modified forms are included in the scope of the present invention as long as the operations and effects of the present invention are exhibited.

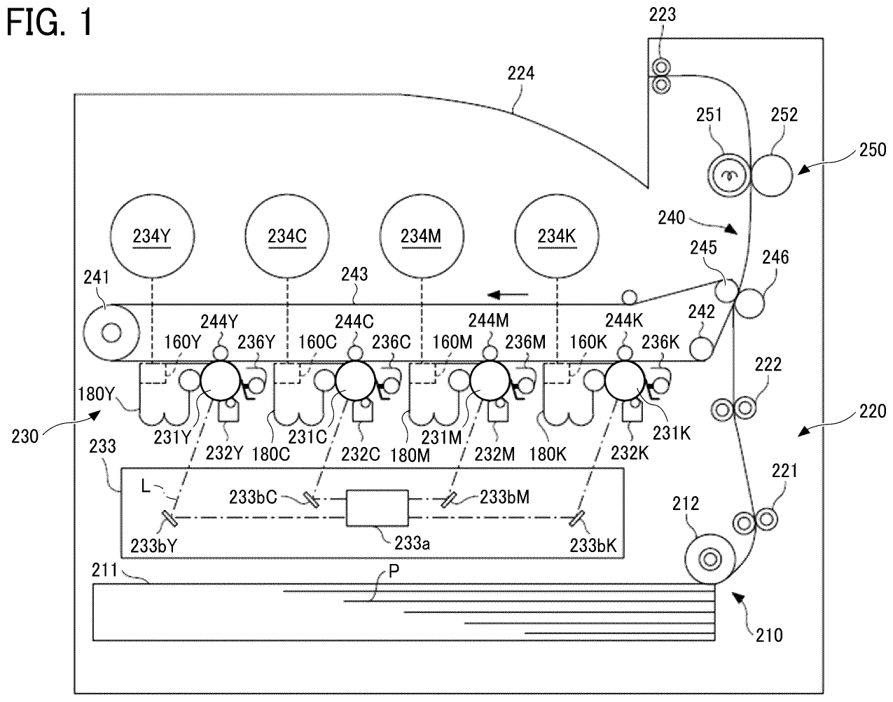

A method of forming an image using the image forming apparatus according to an embodiment of the present invention will be described with reference to FIG. 1. Note that, although a printer is illustrated as an example of the image forming apparatus according to an embodiment of the present invention, the image forming apparatus is not particularly limited as long as the image forming apparatus is capable of forming an image using a toner, such as a copier, a facsimile, or a multifunction peripheral.

FIG. 1 is a schematic view of an image forming apparatus according to an embodiment of the present invention.

The image forming apparatus includes a paper feeding device 210, a transport device 220, an image forming device 230, a transfer device 240, and a fixing device 250.

The paper feeding device 210 includes a paper feeding cassette 211 on which paper sheets P to be fed are stacked, and a paper feeding roller 212 that feeds the paper sheets P stacked on the paper feeding cassette 211 one sheet at a time.

The transport device 220 includes a pair of rollers 221 that transport the paper sheet P fed by the paper feeding roller 212 in the direction toward the transfer device 240, a pair of timing rollers 222 that sandwich a leading end portion of the paper sheet P transported by the rollers 221 so as to stand by, and then feed the paper sheet P to the transfer device 240 at a predetermined timing, and a pair of paper ejection rollers 223 that discharge the paper sheet P, on which a color toner image has been fixed, onto a paper ejection tray 224.

The image forming device 230 includes, spaced at a predetermined intervals from left to right in FIG. 1, an image forming device 180Y that forms an image using a developer including yellow toner, an image forming device 180C that uses a developer including cyan toner, an image forming device 180M that uses a developer including magenta toner, an image forming device 180K that uses a developer including black toner, and an exposure device 233.

The image forming devices 180 (180Y, 180C, 180M, 180K) are provided so as to be capable of rotating in a clockwise direction in FIG. 1, and each include photoconductor drum 231 (231Y, 231C, 231M, 231K) on which an electrostatic latent image and a toner image are formed, a charger 232 (232Y, 232C, 232M, 232K) that uniformly charges the surface of the photoconductor drum 231 (231Y, 231C, 231M, 231K), and a cleaner 236 (236Y, 236C, 236M, 236K) that removes the toner remaining on the surface of the photoconductor drum 231 (231Y, 231C, 231M, 231K).

The image forming devices 180 (180Y, 180C, 180M, 180K) include a toner bottle 234 (234Y, 234C, 234M, 234K) that accommodates toner of each color, and a sub-hopper 160 (160Y, 160C, 160M, 160K) for replenishing the toner supplied from toner bottle 234 (234Y, 234C, 234M, 234K).

Note that an arbitrary image forming device among the image forming devices 180 (180Y, 180C, 180M, 180K) will sometimes be referred to as an image forming device.

The exposure device 233 irradiates the photoconductor drums 231 with laser light L emitted from a light source 233a based on image information, by reflecting the light on polygon mirrors 233b (233bY, 233bC, 233bM, 233bK) that are rotationally driven by a motor.

Furthermore, the developer includes a toner and a carrier. The four image forming devices 180 (180Y, 180C, 180M, 180K) have substantially the same mechanical configuration, except that the developers used are different.

The transfer device 240 includes a drive roller 241, a driven roller 242, an intermediate transfer belt 243 that is capable of rotating counterclockwise in FIG. 1 as the drive roller 241 is driven, primary transfer rollers 244 (244Y, 244C, 244M, 244K) sandwiching the intermediate transfer belt 243 and provided opposing the photoconductor drums 231 (231Y, 231C, 231M, 231K), and a secondary opposing roller 245 and a secondary transfer roller 246 that are opposingly provided sandwiching the intermediate transfer belt 243 at the transfer position of the toner image to the paper.

Note that, in the present embodiment, an elastic intermediate transfer belt can be used as the intermediate transfer belt 243. As the elastic intermediate transfer belt, for example, a belt in which a flexible elastic layer is laminated on a rigid base layer that provides relatively flexible properties can be used.

Furthermore, to prevent the intermediate transfer belt 243 from meandering, a skew preventing guide member may be provided on the inner circumferential surface of the intermediate transfer belt 243.

The fixing device 250 is provided with an internal heater, and includes a pressure roller 252 that forms a nip by rotatably pressurizing a fixing belt 251, which heats the paper sheets P, against the fixing belt 251. As a result, heat and pressure are applied to the color toner image on the paper sheets P, and the color toner image is fixed.

The paper sheet P on which the color toner image has been fixed is ejected onto the paper ejection tray 224 by the paper ejection rollers 223, completing the series of image forming processes.

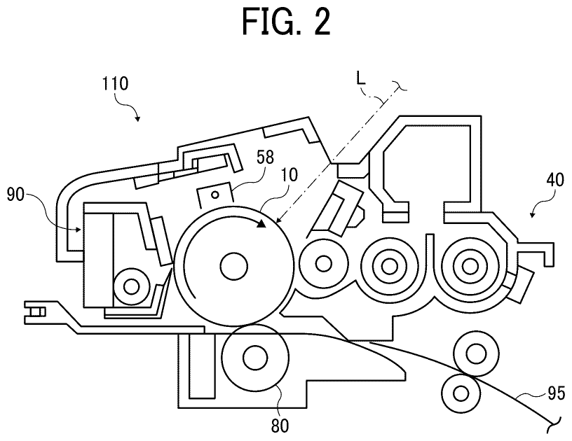

FIG. 2 illustrates a process cartridge, which is an example of a toner storage container according to an embodiment of the present invention. A process cartridge 110 includes a photoconductor drum 10, a corona charger 58, a developing device 40, a transfer roller 80, and a cleaning device 90. An electrostatic latent image is formed on the photoconductor drum 10 by an exposure light L. An image is formed on a recording paper sheet 95 by the process cartridge 110.

### EXAMPLES

Hereinafter, embodiments of the present invention are described in more detail with reference to Examples and Comparative Examples. However, the embodiments are not limited to the Examples and Comparative Examples.

### Manufacturing Example A-1: Synthesis of Amorphous Polyester Resin A-1

### —Synthesis of Prepolymer A-1—

To a reaction vessel equipped with a cooling tube, a stirrer, and a nitrogen inlet tube, 3-methyl-1,5-pentanediol, isophthalic acid, and plant-derived sebacic acid were added together with titanium tetraisopropoxide (1,000 ppm relative to the resin component), such that the molar ratio of OH/COOH between the hydroxyl groups and the carboxyl groups was 1.1, the diol component was 100 mol % 3-methyl-1,5-pentanediol, the dicarboxylic acid component was 73 mol % isophthalic acid and 23 mol % sebacic acid, and the amount of trimethylolpropane among all monomers was 1.5 mol %. Subsequently, the temperature was raised to 200° C. over about 4 hours, and then raised to 230° C. over 2 hours, and the reaction was continued until water was no longer discharged. Then, the mixture was further reacted for 5 hours under a reduced pressure of 10 mmHg to 15 mmHg to obtain [intermediate polyester A-1].

Next, to a reaction vessel equipped with a cooling tube, a stirrer, and a nitrogen inlet tube, the [intermediate polyester A-1] and isophorone diisocyanate (IPDI) were added in a molar ratio (isocyanate groups of IPDI/hydroxyl groups of intermediate polyester) of 2.0, and the mixture was diluted with ethyl acetate to give a 50% ethyl acetate solution. Then, the solution was reacted at 150° C. for 4 hours to obtain [prepolymer A-1].

### —Synthesis of Amorphous Polyester Resin A-1—

The obtained [prepolymer A-1] was stirred in a reaction vessel equipped with a heating device, a stirrer, and a nitrogen inlet tube. Then, [ketimine compound 1] was added dropwise to the reaction vessel in an amount that caused the amount of amine in [ketimine compound 1] to be equimolar to the amount of isocyanate in [prepolymer A-1]. After stirring the mixture at 45° C. for 10 hours, a prepolymer extension product was extracted. The obtained prepolymer extension product was dried under reduced pressure at 50° C. until the amount of residual ethyl acetate was 100 ppm or less to obtain [amorphous polyester resin A-1]. The obtained [amorphous polyester resin A-1] had a glass transition temperature (Tg) of −51° C. and a weight average molecular weight (Mw) of 17,000.

Note that ketimine compound 1 was obtained by charging 170 parts by mass of isophoronediamine and 75 parts by mass of methyl ethyl ketone into a reaction vessel equipped with a stirrer bar and a thermometer, and reacting the mixture at 50° C. for 5 hours.

### <Synthesis of Amorphous Polyester Resin B-1>

To a four-neck flask equipped with a nitrogen inlet tube, a dehydration tube, a stirrer, and a thermocouple, a bisphenol A 2-molar ethylene oxide adduct, a bisphenol A 2-molar propylene oxide adduct, terephthalic acid, and adipic acid were added to obtain a mixture such that the molar ratio between the bisphenol A 2-molar propylene oxide adduct and the bisphenol A 2-molar ethylene oxide adduct in a molar ratio (bisphenol A 2-molar propylene oxide adduct/bisphenol A 2-molar ethylene oxide adduct) was 60/40, the molar ratio between terephthalic acid and adipic acid (terephthalic acid/adipic acid) was 97/3, and the molar ratio of OH/COOH between the hydroxyl groups and the carboxyl groups was 1.3. The mixture was reacted together with titanium tetraisopropoxide (500 ppm relative to the resin component) at normal pressure and 230° C. for 8 hours, and then further reacted at a reduced pressure of 10 mmHg to 15 mmHg for 4 hours. Then, trimellitic anhydride was added to the reaction vessel in an amount of 1 mol % relative to the total resin component, and the mixture was reacted at 180° C. under normal pressure for 4 hours to obtain [amorphous polyester resin B-1]. The obtained [amorphous polyester resin B-1] had a glass transition temperature (Tg) of 65° C. and a weight average molecular weight (Mw) of 9,000.

### <P-1: Introduction of PET>

Recycled PET (P-1) in the form of flakes was mixed so that the solid content ratio presented in Table 1 was obtained when the materials were mixed.

### <Synthesis of Crystalline Polyester Resin C-1>

To a 5 L four-neck flask equipped with a nitrogen inlet tube, a dehydration tube, a stirrer, and a thermocouple, sebacic acid and ethylene glycol were added to obtain a mixture such that the molar ratio of OH/COOH between the hydroxyl groups and the carboxyl groups was 0.9. The mixture was reacted together with titanium tetraisopropoxide (500 ppm relative to the resin component) at 180° C. for 10 hours. Then, the temperature was raised to 200° C. and the mixture was reacted for 3 hours, and the mixture was reacted for a further 2 hours under a pressure of 8.3 kPa to obtain [crystalline polyester resin C-1]. The obtained [crystalline polyester resin C-1] had a melting point of 72° C. and a weight average molecular weight (Mw) of 20,000.

### <Manufacturing of Crystalline Polyester Resin Dispersion Liquid C-1>

To a container equipped with a stirrer bar and a thermometer were charged 45 parts by mass of [crystalline polyester resin C-1] and 450 parts by mass of ethyl acetate. Then, the temperature was raised to 80° C., and then after keeping the temperature at 80° C. for 5 hours, the mixture was cooled to 30° C. over 1 hour. The mixture was dispersed using a bead mil (ULTRA VISCOMILL, manufactured by Aimex Co., Ltd.) at a liquid delivery rate of 1 kg/hr, a disk circumferential speed of 6 m/sec, addition of 80 vol % of zirconia beads having a diameter of 0.5 mm, and 3 passes, to obtain [crystalline polyester resin dispersion liquid C-1]. The volume average particle size of the resulting crystalline polyester resin particle was 450 nm, and the solid content concentration of the resin particle was 10%.

### <Manufacturing of Shell Polyester Resin SR>

To a reaction tank equipped with a cooling tube, a stirrer, and a nitrogen inlet tube were charged 7.5 parts by mass of adipic acid, 63.5 parts by mass of terephthalic acid, and 4.8 parts by mass of succinic acid as acid monomers, and 35.5 parts by mass of Bis-A-EO 2-molar adduct, 58.2 parts by mass of Bis-A-PO 2-molar adduct, 23.4 parts by mass of 1,2-propanediol, and 1 part by mass of trimethylolpropane as alcohol monomers, such that the molar ratio of OH/COOH between the hydroxyl groups and the carboxyl groups was 1.2. Further, 1,000 ppm of tetrabutoxy titanate based on the total monomer amount was added as a condensation catalyst, and the temperature was raised to 200° C. over 2 hours under a nitrogen stream. The temperature was raised further to 230° C. over 8 hours, and the reaction was carried out for 5 hours while distilling off the produced water. Then, the mixture was reacted for 1 hour under reduced pressure of 5 mmHg to 15 mmHg, and cooled to 200° C. Further, 4.5 parts by mass of trimellitic anhydride was added, and the mixture was reacted for 1 hour at normal pressure and 200° C. Then, the mixture was further reacted under reduced pressure of 5 mmHg to 20 mmHg until the desired molecular weight was reached, to obtain [shell polyester resin SR]. Recycled PET in the form of flakes was mixed such that the solid content ratio was 30% when the acid monomer and alcohol monomer materials described above were mixed.

### <Preparation of Shell Polyester Resin Solution>

In a container were placed 200 parts of [shell polyester resin SR] and 200 parts of methyl ethyl ketone, and the mixture was mixed for 60 minutes at 5,000 rpm with a TK HOMOMIXER (manufactured by Primix Corporation) to obtain [shell polyester resin solution 1]. The solids concentration of the obtained [shell polyester resin solution 1] was 50%.

### <<Calculation Method of Solid Concentration in Shell Polyester Resin Solution>>

The solids concentration of [shell polyester resin solution 1] was calculated from the remaining amount by precisely weighing 0.9000 g to 1.0000 g of [shell polyester resin solution] into an aluminum container, leaving the solution in a thermostatic chamber with an internal temperature set to 150° C. for 1 hour, removing the aluminum container from the thermostatic chamber, and then calculating the solids concentration according to the following formula from the residual mass.

Solids concentration [%]=(Residual mass after solution is left at 150° C. for 1 hour [g]/(Mass of precisely weighed [shell polyester resin solution 1])×100

### <Preparation of Shell Aqueous Phase 1>

A mixture containing 468 parts of water and 132 parts of methyl ethyl ketone was stirred to obtain a milky white liquid. The resulting mixture is referred to as [shell aqueous phase 1].

### <Preparation of Shell Polyester Resin Emulsion SR>

While stirring 400 parts of the solution of [shell polyester resin solution 1] with a TK HOMOMIXER (manufactured by Primix Corporation) at a rotation speed of 8,000 rpm, 28% ammonia water was added in an amount equivalent to a neutralization rate of 100% relative to the acid value of [polyester resin emulsion resin SR]. After mixing the mixture for 10 minutes, 600 parts of [shell aqueous phase 1] was gradually added dropwise to cause phase inversion emulsification of [shell polyester resin solution 1]. Further, the phase inversion emulsified [shell polyester resin solution 1] was subjected to solvent removal using an evaporator to obtain [shell polyester resin emulsion SR].

### <Preparation of Wax Dispersion Liquid 1>

To 720 parts by mass of ion-exchanged water were added 180 parts by mass of ester wax (WE-11, manufactured by NOF Corporation, synthetic wax made from plant-derived monomers, melting point 67° C.) and 17 parts by mass of an anionic surfactant (Neogen SC, sodium dodecylbenzenesulfonate, manufactured by Dai-ichi Kogyo Seiyaku Co., Ltd.). The mixture was dispersed using a homogenizer while being heated to 90° C. to obtain [wax dispersion liquid 1]. The wax particles included in the obtained [wax dispersion liquid 1] had a volume average particle size of 300 nm, and the solid concentration of the resin particle was 25%.

### <Preparation of Masterbatch (MB) 1>

To a Henschel mixer (manufactured by Nippon Coke and Engineering Co., Ltd.) were added and mixed 1,200 parts by mass of water, 500 parts by mass of carbon black (Printex 35, manufactured by Degussa) [DBP oil absorption=42 mL/100 mg, pH=9.5], and 500 parts by mass of [amorphous polyester resin B-1]. The mixture was kneaded using two rolls at 150° C. for 30 minutes, rolled and cooled, and then pulverized with a pulverizer to obtain [masterbatch 1].

### <Manufacturing of Resin Particles>

### Example 1

### (Preparation Step of Oil Phase)

In a container were placed 50 parts by mass of [amorphous polyester resin A-1], 50 parts by mass of [crystalline polyester resin dispersion liquid C-1], 50 parts by mass of [wax dispersion liquid 1], 550 parts by mass of [amorphous polyester resin B-1], 300 parts by mass of [P-1], and 100 parts by mass of [masterbatch 1], and the mixture was mixed at 5,000 rpm for 60 minutes with a TK HOMOMIXER (manufactured by Primix Corporation) to obtain [oil phase 1]. The above blending amounts represent the blending amounts of the solid content in each raw material.

### (Preparation Step of Aqueous Phase)

A mixture containing 990 parts by mass of water, 20 parts by mass of sodium dodecyl sulfate, and 90 parts by mass of ethyl acetate was stirred to obtain a milky white liquid. The resulting mixture is referred to as [aqueous phase 1].

### (Manufacturing Step of Emulsified Slurry)

To 700 parts by mass of [oil phase 1] in a TK HOMOMIXER was added 20 parts by mass of 28% ammonia water while stirring at a rotation speed of 8,000 rpm. After mixing the mixture for 10 minutes, 1,200 parts by mass of [aqueous phase 1] was gradually added dropwise to obtain [emulsified slurry 1].

### (Manufacturing Step of Solvent-Free Slurry)

To a container equipped with a stirrer and a thermometer was charged [emulsified slurry 1], and the solvent was removed at 30° C. for 180 minutes to obtain [solvent-free slurry 1].

### (Aggregation Step)

To [solvent-free slurry 1], 30 parts by mass of a 5% calcium chloride solution was added dropwise as a flocculating salt, and stirred for 5 minutes. Then, the temperature was raised to 60° C., and when the particle size reached 5.0 μm, 30 parts by mass of calcium chloride was added to terminate the aggregation step to obtain [aggregated slurry 1].

The shell formation step described below was applied only to Example 7.

### (Shell Formation Step)

To [aggregated slurry 1] was added 80 parts by mass of [shell polyester resin emulsion SR] (solid concentration: 25% by mass), and a 20% by mass aqueous magnesium sulfate solution was slowly added dropwise at a rate of 1 part by mass/min while stirring the mixture, until the Brownian motion of the particles in the system stopped as observed with an optical microscope.

### (Fusion Step)

The [aggregated slurry 1] was heated at 70° C. for 3 hours while stirring to obtain [dispersed slurry 1].

### (Washing and Drying Steps)

After filtering 100 parts of [dispersed slurry 1] under a reduced pressure, the following operations (1) to (4) were carried out three times to obtain [filter cake 1].
(1): 100 parts of ion-exchanged water was added to the filter cake, mixed with a TK HOMOMIXER (at a rotation speed of 12,000 rpm for 10 minutes), and then filtered.
(2): 100 parts of a 10% aqueous sodium hydroxide solution was added to the filter cake of (1), and the mixture was mixed with a TK HOMOMIXER (at a rotation speed of 12,000 rpm for 30 minutes), followed by filtration under reduced pressure.
(3): 150 parts of 10% hydrochloric acid was added to the filter cake of (2), and the mixture was mixed with a TK HOMOMIXER (at a rotation speed of 12,000 rpm for 20 minutes), and then filtered.
(4): 300 parts of ion-exchanged water was added to the filter cake of (3), mixed with a TK HOMOMIXER (at a rotation speed of 12,000 rpm for 10 minutes), and then filtered.

The obtained [filter cake 1] was dried in a circulating air dryer at 45° C. for 48 hours, and sieved through a mesh having an opening of 75 μm to obtain [resin particle base particles 1].

### (External Additive Treatment Step)

In a Henschel mixer, to 100 parts by mass of [resin particle base particles 1] were mixed the fine particles A and fine particles B as external additives as presented in Table 1, and the mixture was passed through a 500 mesh sieve to obtain [resin particle 1].

Note that the fine particles A were silica fine particles (manufactured by Fuso Chemical Co., Ltd.) that had been hydrophobically treated with HMDS, and having an average particle size of about 160 nm. The fine particles B were silica fine particles (manufactured by Nippon Aerosil Co., Ltd.) that had been hydrophobically treated with HMDS, and having an average particle size of about 30 nm.

### Examples 2 to 7, and Comparative Examples 1 to 6

The resin particles of each of Examples 2 to 7 and Comparative Examples 1 to 6 were produced in the same manner as in Example 1, except that the heating temperature, the amount of PET added, the time, and the type and amount of the external additive in the fusion step were changed as presented in Table 1. The characteristics of the obtained resin particles are presented in Table 2. In Table 2, the unit of the BET specific surface area is m²/g, and the content ratio of the fine particles A/fine particles B is a mass ratio.

TABLE 1

| | | PET | | | Fine particles A | | Fine particles B | |
|---|---|---|---|---|---|---|---|---|
| | | addition | Fusion | | | Addition | | Addition |
| | | amount [parts | temperature | Fusion | Particle | amount [parts | Particle | amount [parts |
| | | by mass] | [° C.] | time [h] | size [nm] | by mass] | size [nm] | by mass] |
| Examples | 1 | 300 | 70 | 3 | 160 nm | 1.0 | 30 nm | 2.0 |
| | 2 | 300 | 70 | 1 | 100 nm | 1.0 | 30 nm | 2.0 |
| | 3 | 300 | 70 | 1 | 100 nm | 1.4 | 30 nm | 1.0 |
| | 4 | 300 | 70 | 3 | 100 nm | 1.4 | 30 nm | 1.0 |
| | 5 | 300 | 70 | 2 | 100 nm | 1.1 | 30 nm | 1.2 |
| | 6 | 500 | 70 | 2 | 100 nm | 1.1 | 30 nm | 1.2 |
| | 7 | 500 | 70 | 2 | 100 nm | 1.1 | 30 nm | 1.2 |
| Comparative | 1 | 300 | 72 | 5 | 100 nm | 1.1 | 30 nm | 1.2 |
| Examples | 2 | 300 | 65 | 1 | 100 nm | 1.1 | 30 nm | 1.2 |
| | 3 | 300 | 70 | 2 | 100 nm | 2.0 | 30 nm | 1.1 |
| | 4 | 300 | 70 | 2 | None | 0.0 | 30 nm | 1.2 |
| | 5 | 300 | 70 | 2 | 100 nm | 1.1 | 60 nm | 1.2 |
| | 6 | None | 70 | 2 | 100 nm | 1.1 | 30 nm | 1.2 |

TABLE 2

| | | BET specific | Fine particles A/ | PET content |
|---|---|---|---|---|
| | | surface area | fine particles B | [% by mass] |
| Examples | 1 | 0.8 | 0.5 | 30 |
| | 2 | 1.4 | 0.5 | 30 |
| | 3 | 1.4 | 1.4 | 30 |
| | 4 | 0.8 | 1.4 | 30 |
| | 5 | 1.1 | 0.9 | 30 |
| | 6 | 1.1 | 0.9 | 50 |
| | 7 | 1.1 | 0.9 | 55 |
| Comparative | 1 | 0.7 | 0.9 | 30 |
| Examples | 2 | 1.5 | 0.9 | 30 |
| | 3 | 1.1 | 1.8 | 30 |
| | 4 | 1.1 | 0 | 30 |
| | 5 | 1.1 | 0.9 | 30 |
| | 6 | 1.1 | 0.9 | 0 |

### <Evaluation of Characteristics>

The resin particles of each of the Examples and Comparative Examples described above were used as the toner, and the toner properties, such as the environmental friendliness, low-temperature fixing properties, image quality, and charging properties, were evaluated. The evaluation results are presented in Table 3.

### [Environmental Friendliness]

The environmental friendliness was evaluated based on the ratio of environmentally friendly resin in the toner, according to the following evaluation criteria.

### (Evaluation Criteria)

A: Recycled resin is 50% or more
B: Recycled resin is 30% or more and less than 50%
C: Recycled resin is less than 30%

It is possible to determine that A and B evaluations indicate sufficient environmental friendliness.

### [Image Quality]

The image quality was evaluated by observing the reproducibility of fine lines. The resin particles were placed in an IMAGEO MP C5503 (manufactured by Ricoh Co., Ltd.), and a printing test of 6-point and 10-point characters was carried out in an environment with a temperature of 30° C. and a relative humidity of 80%. The reproducibility of the printed characters was evaluated on a three-level scale based on the following evaluation criteria.

### (Evaluation Criteria)

A: 6-point characters are clear
B: Some 6-point characters are blurry
C: Some 10-point characters are blurry

It is possible to determine that A and B evaluations indicate sufficient image quality.

### <Heat Resistant Storage Stability>

The toner was filled into a 50 mL glass container, and left in a thermostatic chamber at 50° C. for 24 hours, and then cooled to 24° C. Then, a penetration [mm] was measured by a penetration test (JIS K2235-1991) to evaluate the heat-resistant storage stability.

### [Evaluation Criteria]

Excellent: Penetration is 20 mm or more
Good: Penetration is 15 mm or more and less than 20 mm
Fair: Penetration is 10 mm or more and less than 15 mm
Poor: Penetration is less than 10 mm

It is possible to determine that Excellent and Good evaluations indicate sufficient heat-resistant storage stability.

### [Charging Properties]

The carrier used in IMAGEO MP C5503 (manufactured by Ricoh Co., Ltd.) and the resin particles obtained above were mixed such that the concentration of the resin particles was 7% by mass, to obtain the developer. The developer was set in an IMAGEO MP C5503 (manufactured by Ricoh Co., Ltd.), and a running test was performed with respect to 300,000 sheets of an image chart having a 50% image area in a monochrome mode. Then, after the running test, the change in charge amount of the carrier was determined based on the following evaluation criteria, and the charging properties were evaluated. The change in the charge amount was calculated as follows. That is, the humidity of the sample was adjusted in an unsealed system for 30 minutes or more in an environment of 23° C. temperature and 50% relative humidity (M/M environment), and 6.000 g of the initial carrier and 0.452 g of the toner were added to a stainless-steel container. Then, the container was sealed, and an YS-LD (a shaker manufactured by Yayoi Co., Ltd.) was operated for 5 minutes at a 150 setting to triboelectrically charge the sample by shaking the sample approximately 1,100 times. The change in the charge amount was obtained as |Q1−Q2|, where Q1 represents the charge amount of the sample using a general blow-off method (TB-200 manufactured by Toshiba Chemical Co., Ltd.), and Q2 represents the charge amount measured by the same method for a carrier obtained by removing the toner in the developer after the running test using the blow-off device.

### (Evaluation Criteria)

A: Change in charge amount is less than 10 μc/g
B: Change in charge amount is 10 μc/g or more and less than 20 μc/g
C: Change in charge amount is 20 μc/g or more

It is possible to determine that A and B evaluations indicate sufficient charging properties.

TABLE 3

| | | | Heat-resistant | | |
|---|---|---|---|---|---|
| | | | storage | Image | Environmental |
| | | Charging | stability | quality | friendliness |
| Examples | 1 | B | Good | B | B |
| | 2 | A | Good | B | B |
| | 3 | A | Excellent | B | B |
| | 4 | B | Excellent | B | B |
| | 5 | B | Good | B | B |
| | 6 | A | Excellent | B | A |
| | 7 | A | Excellent | A | A |
| Comparative | 1 | C | Good | B | B |
| Examples | 2 | C | Poor | B | B |
| | 3 | B | Poor | B | B |
| | 4 | B | Good | C | B |
| | 5 | B | Poor | B | B |
| | 6 | C | Fair | B | C |

From Table 3, it was confirmed that the resin particles of Examples 1 to 7 were toners that satisfied all of the conditions for use in terms of the environmental friendliness, heat resistant storage stability, image quality, and charging properties. By contrast, the resin particles obtained in Comparative Examples 1 to 6 did not satisfy the conditions for use in terms of at least one of the environmental friendliness, heat resistant storage stability, image quality, and charging properties, and it was confirmed that the toners were problematic in practical use.

An embodiment has been described above. However, the embodiment has been presented as an example, and the present invention is not limited to the embodiment described above. The embodiment described above can be implemented in various other forms, and various combinations, omissions, substitutions, changes, and the like, can be made without departing from the gist of the invention. The embodiment and modifications thereof fall within the scope and spirit of the invention, and is included in the scope of the invention described in the claims and equivalents thereof.

Note that, for example, an embodiment of the present invention is as follows.

A first aspect is a resin particle including: a base particle including at least one of polyethylene terephthalate or polybutylene terephthalate and having a BET specific surface area of 0.8 to 1.4 m²/g, and an external additive including fine particles A having an average particle size of 100 nm or more and fine particles B having an average particle size of 10 to 50 nm, a mass ratio A/B of the fine particles A to the fine particles B being 0.5 to 1.4.

A second aspect is the resin particle according to the first aspect, wherein the base particle further includes an amorphous resin, a crystalline resin, and a release agent.

A third aspect is the resin particle according to the first or second aspect, wherein a content of the at least one of polyethylene terephthalate or polybutylene terephthalate in the resin particle is 30% by mass or more.

A fourth aspect is the resin particle according to any one of the first to third aspects, wherein the base particle has a core-shell structure, and the core-shell structure includes a shell portion containing the at least one of polyethylene terephthalate or polybutylene terephthalate.

A fifth aspect is a method of manufacturing the resin particle according to any one of the first to fourth aspects, the method comprising: preparing a solution in which a resin including the at least one of polyethylene terephthalate or polybutylene terephthalate is dissolved or dispersed in an organic solvent; adding water to the solution to induce phase inversion from a water-in-oil dispersion liquid to an oil-in-water dispersion liquid; aggregating fine particles in the oil-in-water dispersion liquid; and attaching the external additive to the base particle.

A sixth aspect is a toner comprising the resin particle according to any one of the first to fourth aspects.

A seventh aspect is a toner storage container that accommodates the toner according to the sixth aspect.

An eighth aspect is an image forming apparatus comprising:
an electrostatic latent image bearer;
an electrostatic latent image forming device that forms an electrostatic latent image on the electrostatic latent image bearer; and
a developing device that develops the electrostatic latent image that has been formed on the electrostatic latent image bearer with the toner according to the sixth aspect to form a toner image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A resin particle comprising:
a base particle including at least one of polyethylene terephthalate or polybutylene terephthalate and having a BET specific surface area of 0.8 to 1.4 m²/g; and
an external additive including fine particles A having an average particle size of 100 nm or more and fine particles B having an average particle size of 10 to 50 nm, a mass ratio A/B of the fine particles A to the fine particles B being 0.5 to 1.4.

2. The resin particle according to claim 1, wherein the base particle further includes an amorphous resin, a crystalline resin, and a release agent.

3. The resin particle according to claim 1, wherein a content of the at least one of polyethylene terephthalate or polybutylene terephthalate in the resin particle is 30% by mass or more.

4. The resin particle according to claim 1, wherein the base particle has a core-shell structure, and the core-shell structure includes a shell portion containing the at least one of polyethylene terephthalate or polybutylene terephthalate.

5. A method of manufacturing the resin particle according to claim 1, the method comprising:
preparing a solution in which a resin including the at least one of polyethylene terephthalate or polybutylene terephthalate is dissolved or dispersed in an organic solvent;
adding water to the solution to induce phase inversion from a water-in-oil dispersion liquid to an oil-in-water dispersion liquid;
aggregating fine particles in the oil-in-water dispersion liquid; and
attaching the external additive to the base particle.

6. A toner comprising the resin particle according to claim 1.

7. A toner storage container that accommodates the toner according to claim 6.

8. An image forming apparatus comprising:
an electrostatic latent image bearer;
an electrostatic latent image forming device that forms an electrostatic latent image on the electrostatic latent image bearer; and
a developing device that develops the electrostatic latent image that has been formed on the electrostatic latent image bearer with the toner according to claim 6 to form a toner image.
